(19) United States
(12) Patent Application Publication
(10) Pub. No.: US 2025/0258369 A1
(43) Pub. Date: Aug. 14, 2025

(54) LIGHT SCANNING APPARATUS AND IMAGE FORMING APPARATUS

(71) Applicant: CANON KABUSHIKI KAISHA, Tokyo (JP)

(72) Inventors: MASAYASU TERAMURA, Tochigi (JP); SOYA SAIJO, Tochigi (JP)

(21) Appl. No.: 19/041,774

(22) Filed: Jan. 30, 2025

(30) Foreign Application Priority Data
Feb. 13, 2024 (JP) 2024-019123

(51) Int. Cl. G02B 26/12; G02B 26/10; G03G 15/043

(52) U.S. Cl. CPC G02B 26/124; G02B 26/105; G02B 26/125; G03G 15/0435

(57) ABSTRACT

Provided is an apparatus in which a distance between a light source and a deflecting surface of a deflecting unit on an optical axis of an incident system, a distance between the deflecting surface and a sagittal line tilt surface of an imaging element on an optical axis of the imaging element, a lateral magnification in a sub-scanning cross section of the incident system, and an inclination of the sagittal line tilt surface at a position at which a light flux from each light emitting point of the light source arrives on the sagittal line tilt surface are appropriately set.

### BACKGROUND

### Technical Field

The present disclosure is related to a light scanning apparatus, and more particularly to a light scanning apparatus suitably used in an image forming apparatus such as a laser beam printer (LBP), a digital copying machine and a multi-function printer (MFP).

### Description of the Related Art

Conventionally, there is known a light scanning apparatus which scans a scanned surface by using multiple beams emitted from a light source with a plurality of light emitting points to increase a speed.

On the other hand, in such light scanning apparatus, it is also known that image quality may deteriorate due to an occurrence of a deviation between scanning widths (overall magnifications) of the multiple beams.

Japanese Patent Application Laid-open No. H09-197308 discloses a light scanning apparatus that reduces a deviation between scanning widths of multiple beams by using a deviation between scanning widths corresponding to incident angles of the multiple beams with respect to a scanned surface.

### SUMMARY

The apparatus according to the embodiments includes a deflecting unit configured to deflect a plurality of light fluxes from a first light source with a plurality of light emitting points to scan a first scanned surface in a main scanning direction, a first element having a first surface and configured to guide the plurality of light fluxes deflected by a first deflecting surface of the deflecting unit to the first scanned surface, and a first incident system configured to cause the plurality of light fluxes from the first light source to be incident on the first deflecting surface, in which a following condition is satisfied:

$$0.05 < \vert {M}_{1 i} [ - {β}_{1} + \frac{( 1 - {β}_{1} ) {D}_{1}}{{L}_{1}} ] \vert < 0.7 ,$$

where L₁ represents a distance between the first light source and the first deflecting surface on an optical axis of the first incident system, D₁ represents a distance between the first deflecting surface and the first surface on an optical axis of the first element, β₁ represents a lateral magnification in a sub-scanning cross section of the first incident system, and M₁ᵢ represents an inclination of the first surface at a position at which the light flux from an i-th light emitting point of the first light source arrives on the first surface.

Further features of the disclosure will become apparent from the following description of exemplary embodiments with reference to the attached drawings.

### BRIEF DESCRIPTION OF THE DRAWINGS

FIG. 1A is a main scanning cross sectional view of a light scanning apparatus according to a first embodiment of the disclosure.

FIG. 1B is a partial sub-scanning cross sectional view of the light scanning apparatus according to the first embodiment.

FIG. 2 is a diagram for explaining an effect in the light scanning apparatus according to the first embodiment.

FIG. 3A is a view showing a state in which a plurality of light beams arrive at respective image heights on a scanned surface in the light scanning apparatus according to the first embodiment.

FIG. 3B is a view showing a state in which a plurality of light beams arrive at respective image heights on a scanned surface in the light scanning apparatus according to the first embodiment.

FIG. 4 is a graph showing an image height dependence of a distance between the arrival positions of light beams on the scanned surface in the light scanning apparatus according to the first embodiment.

FIG. 5A is a main scanning cross sectional view of a light scanning apparatus according to a second embodiment of the disclosure.

FIG. 5B is a partial sub-scanning cross sectional view of the light scanning apparatus according to the second embodiment.

FIG. 6 is a graph showing an image height dependence of a distance between arrival positions of light beams on a scanned surface in the light scanning apparatus according to the second embodiment.

FIG. 7A is a main scanning cross sectional view of a light scanning apparatus according to a third embodiment of the disclosure.

FIG. 7B is a partial sub-scanning cross sectional view of the light scanning apparatus according to the third embodiment.

FIG. 8 is a graph showing an image height dependence of a distance between arrival positions of light beams on a scanned surface in the light scanning apparatus according to the third embodiment.

FIG. 9A is a partial developed view in a main scanning cross section of a light scanning apparatus according to a fourth embodiment of the disclosure.

FIG. 9B is a partial developed view in the main scanning cross section of the light scanning apparatus according to the fourth embodiment.

FIG. 10 is a partial developed view in a sub-scanning cross section of the light scanning apparatus according to the fourth embodiment.

FIG. 11 is a partial sub-scanning cross sectional view of the light scanning apparatus according to the fourth embodiment.

FIG. 12A is a graph showing an image height dependence of a distance between arrival positions of light beams on a scanned surface in the light scanning apparatus according to the fourth embodiment.

FIG. 12B is a graph showing an image height dependence of a distance between arrival positions of light beams on a scanned surface in the light scanning apparatus according to the fourth embodiment.

FIG. 13 is a developed view in the main scanning cross section of a light scanning apparatus according to a fifth embodiment of the disclosure.

FIG. 14 is a partial developed view in the sub-scanning cross section of the light scanning apparatus according to the fifth embodiment.

FIG. 15 is a partial sub-scanning cross sectional view of the light scanning apparatus according to the fifth embodiment.

FIG. 16 is a sub-scanning cross sectional view of a main part of an image forming apparatus according to the aspect of the embodiments.

### DESCRIPTION OF THE EMBODIMENTS

Hereinafter, a light scanning apparatus according to the aspect of the embodiments is described in detail with reference to accompanying drawings. Note that the drawings described below may be drawn on a scale different from an actual scale in order to facilitate understanding of the disclosure.

In the following description, a main scanning direction is a direction perpendicular to a rotation axis of a deflecting unit and an optical axis of an optical system. A sub-scanning direction is a direction parallel to the rotation axis of the deflecting unit. A main scanning cross section is a cross section perpendicular to the sub-scanning direction. The sub-scanning cross section is a cross section perpendicular to the main scanning direction.

Accordingly, in the following description, it should be noted that the main scanning direction and the sub-scanning cross section are different between an incident optical system and an imaging optical system.

### First Embodiment

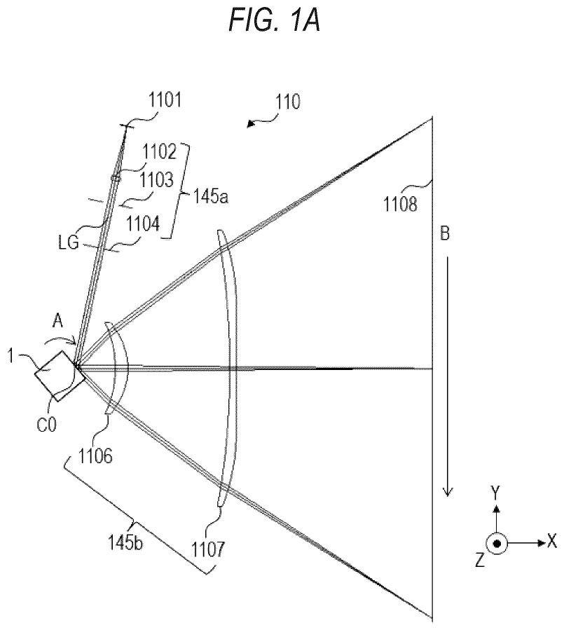

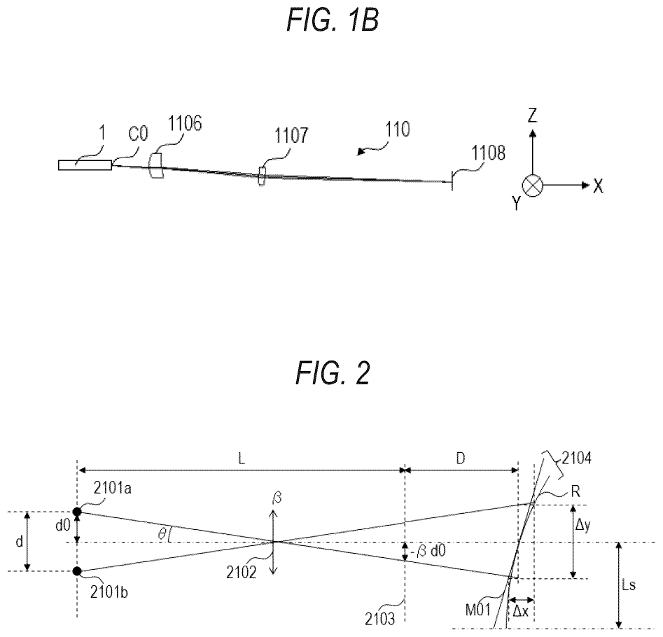

FIGS. 1A and 1B show a schematic main scanning cross sectional view and a schematic partial sub-scanning cross sectional view of a light scanning apparatus 110 according to a first embodiment of the disclosure, respectively.

The light scanning apparatus 110 according to the aspect of the embodiment includes a light source 1101 (first light source), an anamorphic collimator lens 1102, a sub-scanning stop 1103, a main scanning stop 1104, a deflecting unit 1, a first fθ lens 1106 (first optical element, first imaging optical element), and a second fθ lens 1107.

On an optical path, the first fθ lens 1106 is arranged between the deflecting unit 1 and the second fθ lens 1107.

As the light source 1101, a semiconductor laser (multibeam laser) or the like having a plurality of light emitting points is used.

The anamorphic collimator lens 1102 converts a light flux LG emitted from the light source 1101 into a parallel light flux in the main scanning cross section, and condenses the light flux LG in the sub-scanning cross section. The parallel light flux includes not only a strictly parallel light flux but also a substantially parallel light flux such as a weakly divergent light flux or a weakly convergent light flux.

The sub-scanning stop 1103 limits a light flux diameter in the sub-scanning direction of the light flux LG that has passed through the anamorphic collimator lens 1102.

The main scanning stop 1104 limits a light flux diameter in the main scanning direction of the light flux LG that has passed through the sub-scanning stop 1103.

With the above-described configuration, the light flux LG emitted from the light source 1101 is condensed in the sub-scanning direction in the vicinity of a deflecting surface of the deflecting unit 1, so that a line image elongated in the main scanning direction is formed.

The deflecting unit 1 deflects the incident light flux LG with rotating in a direction indicated by an arrow A in FIG. 1A by a driving unit such as a motor (not shown). The deflecting unit 1 is formed by a polygon mirror, for example.

The first fθ lens 1106 and the second fθ lens 1107 are anamorphic imaging lenses having different powers (refractive powers) between the main scanning cross section and the sub-scanning cross section, and condense (guide) the light flux LG deflected by the deflecting unit 1 on the scanned surface 1108 (first scanned surface).

In the light scanning apparatus 110 according to the aspect of the embodiment, an incident optical system 145a is formed by the anamorphic collimator lens 1102, the sub-scanning stop 1103 and the main scanning stop 1104.

Further, in the light scanning apparatus 110 according to the aspect of the embodiment, a scanning optical system 145b (first imaging optical system) is formed by the first fθ lens 1106 and the second fθ lens 1107.

Note that the refractive power in the sub-scanning cross section of the second fθ lens 1107 is stronger than the refractive power in the sub-scanning cross section of the first fθ lens 1106, namely the strongest in the scanning optical system 145b.

The light fluxes LG emitted from the respective light emitting points of the light source 1101 pass through the incident optical system 145a to be incident on the deflecting unit 1.

The light fluxes LG incident on the deflecting unit 1 from the light source 1101 are deflected by the deflecting unit 1 to be guided onto the scanned surface 1108 by the scanning optical system 145b, thereby the scanned surface 1108 is scanned at a constant speed.

Since the deflecting unit 1 rotates in the direction indicated by the arrow A in FIG. 1A, the light fluxes LG deflected by the deflecting unit 1 scan the scanned surface 1108 in a direction indicated by an arrow B in FIG. 1A.

In FIGS. 1A and 1B, CO represents a deflection point (on-axis deflection point) on the deflecting surface of the deflecting unit 1 for a principal ray of an on-axis light flux. The deflection point CO serves as a reference point of the scanning optical system 145b.

In the aspect of the embodiment, a photosensitive drum 1108 is used as the scanned surface 1108. An exposure distribution in the sub-scanning direction on the photosensitive drum 1108 is formed by rotating the photosensitive drum 1108 in the sub-scanning direction for each main scanning exposure.

Next, various characteristics of the incident optical system 145a and the scanning optical system 145b provided in the light scanning apparatus 110 according to the aspect of the embodiment are shown in the following Tables 1 and 2, respectively.

TABLE 1
Characteristics of light source 1101

| | | |
|---|---|---|
| Wavelength | λ(nm) | 790 |
| Incident polarization to deflecting surface of deflecting unit 1 | | p-polarization |
| Full angle at half maximum in main scanning direction | FFPy(deg) | 12.00 |
| Full angle at half maximum in sub-scanning direction | FFPz(deg) | 30.00 |

Shape of stop

| | Main scanning | Sub-scanning |
|---|---|---|
| | direction | direction |
| Sub-scanning stop 1103 | 10.000 | 2.840 |
| Main scanning stop 1104 | 3.750 | — |

Refractive index

| | |
|---|---|
| Anamorphic collimator lens 1102 N1 | 1.5282 |

Shape of optical element

| | | Main | Sub- |
|---|---|---|---|
| | | scanning | scanning |
| | | direction | direction |
| Curvature radius of incident surface | r1a (mm) | ∞ | ∞ |
| of anamorphic collimator lens 1102 | | | |
| Curvature radius of exit surface | r1b (mm) | −37.169 | −26.170 |
| of anamorphic collimator lens 1102 | | | |
| Phase coefficient of incident surface | D2, 0 | −7.847E−03 | — |
| of anamorphic collimator lens 1102 | D0, 2 | — | −8.669E−03 |

Focal length

| | | Main | Sub- |
|---|---|---|---|
| | | scanning | scanning |
| | | direction | direction |
| Anamorphic collimator lens 1102 | fcol | 33.94 | 27.15 |
| | (mm) | | |

Arrangement

| | | |
|---|---|---|
| Light source 1101 - | d0 (mm) | 33.59 |
| Incident surface of anamorphic collimator lens 1102 | | |
| Incident surface of anamorphic collimator lens 1102 - | d1 (mm) | 3.00 |
| Exit surface of anamorphic collimator lens 1102 | | |
| Exit surface of anamorphic collimator lens 1102 - | d2 (mm) | 15.15 |
| Sub-scanning stop 1103 | | |
| Sub-scanning stop 1103 - | d4 (mm) | 29.87 |
| Main scanning stop 1104 | | |
| Main scanning stop 1104 - | d5 (mm) | 80.09 |
| Deflecting surface of deflecting unit 1 | | |
| Incident angle in main scanning cross section of light | A1 (deg) | 78.00 |
| flux exiting from main scanning stop 1104 to deflecting | | |
| surface | | |
| Incident angle in sub-scanning cross section of light | A2 (deg) | −3.00 |
| flux exiting from main scanning stop 1104 to deflecting | | |
| surface | | |

TABLE 2
fθ coefficient, Scanning width, Maximum angle of view

| | | |
|---|---|---|
| fθ coefficient | k (mm/rad) | 207 |
| Scanning width | W (mm) | 330 |
| Maximum angle of view | θ(deg) | 45.7 |
| Refractive index | | |
| Refractive index of first fθ lens 1106 | N5 | 1.5281915 |
| Refractive index of second fθ lens 1107 | N6 | 1.5281915 |
| Deflecting unit 1 | | |
| Number of deflecting surfaces | | 4 |
| Circumscribed radius | Rpol (mm) | 10 |
| Rotation center - Deflection reference point C0 (Optical | Xpol (mm) | 6.03 |
| axis direction) | | |
| Rotation center - Deflection reference point C0 (main | Ypol (mm) | 3.79 |
| scanning direction) | | |
| Arrangement in scanning optical system 145b | | |
| Deflection reference point C0 - | d12 (mm) | 26.00 |
| Incident surface of first fθ lens 1106 | | |
| Incident surface of first fθ lens 1106 - | d13 (mm) | 8.20 |
| Exit surface of first fθ lens 1106 | | |
| Exit surface of first fθ lens 1106 - | d14 (mm) | 66.60 |
| Incident surface of second fθ lens 1107 | | |
| Incident surface of second fθ lens 1107 - | d15 (mm) | 4.30 |
| Exit surface of second fθ lens 1107 | | |
| Exit surface of second fθ lens 1107 - | d16 (mm) | 127.90 |
| Scanned surface 1108 | | |
| Deflection reference point C0 - | L1 (mm) | 26.00 |
| Incident surface of first f0 lens 1106 | | |
| Deflection reference point C0 - | L2 (mm) | 100.80 |
| Incident surface of second fθ lens 1107 | | |
| Deflection reference point C0 - | T2 (mm) | 233.00 |
| Scanned surface 1108 | | |
| Sub-scanning eccentricity of second fθ lens 1107 | shiftZ (mm) | −6.99 |

| Meridional line shape of the first fθ lens 1106 | | | Meridional line shape of the first fθ lens 1107 | | |
|---|---|---|---|---|---|
| | Incident surface | Exit surface | | Incident surface | Exit surface |
| | Opposite light | Opposite light | | Opposite light | Opposite light |
| | source side | source side | | source side | source side |
| R | −70.147 | −42.359 | R | −503.226 | 827.492 |
| ku | 8.795E−01 | −5.295E−01 | ku | 0 | −6.560E+02 |
| B4u | −2.896E−06 | −1.582E−06 | B4u | 0 | −2.864E−07 |
| B6u | 8.878E−09 | 1.735E−09 | B6u | 0 | 2.256E−11 |
| B8u | −8.004E−12 | 1.352E−12 | B8u | 0 | −1.545E−15 |
| B10u | 2.358E−15 | −1.720E−15 | B10u | 0 | 4.648E−20 |
| B12u | 0 | 0 | B12u | 0 | 0.000E+00 |
| | Light source side | Light source side | | Light source side | Light source side |
| kl | 8.795E−01 | −5.295E−01 | kl | 0 | −6.560E+02 |
| B4l | −2.896E−06 | 1.582E−06 | B4l | 0 | −2.864E−07 |
| B6l | 8.878E−09 | 1.735E−09 | B6l | 0 | 2.256E−11 |
| B8l | −8.004E−12 | 1.352E−12 | B8l | 0 | −1.545E−15 |
| B10l | 2.358E−15 | −1.720E−15 | B10l | 0 | 4.648E−20 |
| B12l | 0 | 0 | B12l | 0 | 0.000E+00 |
| Sagittal line shape of first fθ lens 1106 | | | Sagittal line shape of second fθ lens 1107 | | |
| | Incident surface | Exit surface | | Incident surface | Exit surface |
| | Sagittal line R | Sagittal line R | | Sagittal line R | Sagittal line R |
| | change | change | | change | change |
| r | 20.000 | 41.166 | r | 54.140 | −71.92722 |
| E1 | 0 | 0 | E1 | 0.000E+00 | −1.809E−06 |
| E2 | 0 | 5.090E−05 | E2 | −1.678E−06 | 2.363E−07 |
| E3 | 0 | 0 | E3 | 0 | −1.670E−09 |
| E4 | 0 | −3.069E−08 | E4 | 0.000E+00 | −2.510E−10 |
| E5 | 0 | 0 | E5 | 0 | 1.012E−12 |
| E6 | 0 | 8.900E−11 | E6 | 0.000E+00 | 2.098E−14 |
| E7 | 0 | 0 | E7 | 0 | −2.168E−16 |
| E8 | 0 | −1.563E−13 | E8 | 0.000E+00 | −1.099E−18 |
| E9 | 0 | 0 | E9 | 0 | 1.406E−20 |
| E10 | 0 | 9.853E−17 | E10 | 0 | 3.050E−23 |
| | Sagittal line tilt | Sagittal line tilt | | Sagittal line tilt | Sagittal line tilt |
| M0_1 | 0 | −9.182E−02 | M0_1 | 3.060E−02 | 1.325E−01 |
| M1_1 | 0 | 0 | M1_1 | −1.540E−05 | −3.735E−06 |
| M2_1 | 0 | 2.102E−05 | M2_1 | −2.250E−05 | −2.951E−05 |
| M3_1 | 0 | 0 | M3_1 | 6.934E−08 | 5.610E−08 |
| M4_1 | 0 | 0 | M4_1 | 5.046E−09 | 7.008E−09 |
| M5_1 | 0 | 0 | M5_1 | −3.700E−11 | −2.746E−11 |
| M6_1 | 0 | 0 | M6_1 | −1.752E−13 | −8.318E−13 |
| M7_1 | 0 | 0 | M7_1 | 7.276E−15 | 4.760E−15 |
| M8_1 | 0 | 0 | M8_1 | −4.737E−17 | 6.909E−17 |
| M9_1 | 0 | 0 | M9_1 | −4.124E−19 | −2.153E−19 |
| M10_1 | 0 | 0 | M10_1 | 1.935E−21 | −5.004E−21 |
| M11_1 | 0 | 0 | M11_1 | 0 | 0 |
| M12_1 | 0 | 0 | M12_1 | 0 | 0 |

In Tables 1 and 2, the optical axis, an axis orthogonal to the optical axis in the main scanning cross section, and an axis orthogonal to the optical axis in the sub-scanning cross section are defined as an X-axis, a Y-axis, and a Z-axis, respectively, when an intersection between each lens surface and the optical axis is defined as an origin.

Further, in Table 2, “E-x” means “×10^{-x}”.

An aspheric surface shape (meridional line shape) in the main scanning cross section of each lens surface of the first fθ lens 1106 and the second fθ lens 1107 provided in the light scanning apparatus 110 according to the aspect of the embodiment is represented by the following Expression (1):

$$X = \frac{\frac{{Y}^{2}}{R}}{1 + \sqrt{1 - ( 1 + k ) {( \frac{Y}{R} )}^{2}}} + {\sum }_{i = 4 , 6 , 8 , 10 , 12} {B}_{i} {Y}^{i} . \qquad ( 1 )$$

In Expression (1), R represents a curvature radius, k represents an eccentricity, and Bᵢ (i=4, 6, 8, 10 and 12) represent aspheric surface coefficients.

When the coefficient Bᵢ is different between a positive side and a negative side with respect to Y, a subscript u is added to the coefficient on the positive side (namely, Bᵢᵤ), and a subscript 1 is added to the coefficient on the negative side (namely, Bᵢ₁), as shown in Table 2.

An aspheric surface shape (sagittal line shape) in the sub-scanning cross section of each lens surface of the first fθ lens 1106 and the second fθ lens 1107 provided in the light scanning apparatus 110 according to the aspect of the embodiment is represented by the following Expression (2):

$$S = \frac{\frac{{Z}^{2}}{{r}^{′}}}{1 + \sqrt{1 - {( \frac{Z}{{r}^{′}} )}^{2}}} + {\sum }_{j = 0}^{12} {\sum }_{k = 1}^{1} {M}_{j k} {Y}^{j} {Z}^{k} . \qquad ( 2 )$$

In Expression (2), Mⱼₖ (j=0 to 12, and k=1) represent aspheric surface coefficients.

Note that a sagittal line tilt (sagittal line tilt amount) in the aspect of the embodiment indicates the M₀₁. Accordingly, a sagittal line tilt surface refers to a surface whose M₀₁ is not 0.

Further, a curvature radius r′ in the sub-scanning cross section of each lens surface of the first fθ lens 1106 and the second fθ lens 1107 provided in the light scanning apparatus 110 according to the aspect of the embodiment continuously varies in accordance with a position in the Y direction as represented by the following Expression (3):

$${r}^{′} = \frac{1}{\frac{1}{r} + {\sum }_{i = 1}^{10} {E}_{i} {Y}^{i}} . \qquad ( 3 )$$

In Expression (3), r represents the curvature radius on the optical axis, and Eᵢ (i=1 to 10) represent change coefficients.

Furthermore, the anamorphic collimator lens 1102 provided in the light scanning apparatus 110 according to the aspect of the embodiment has an incident surface formed by a diffracting surface defined by an optical path difference function of two variables Y and Z as represented by the following expression (4):

$$φ ( Y , Z ) = \frac{2 π}{λ} {\sum }_{i = 0 , j = 0} {D}_{ij} {Y}^{i} {Z}^{j} . \qquad ( 4 )$$

In Expression (4), λ represents a pitch of a diffraction grating, and Dᵢⱼ represent phase coefficients.

Next, effects of the light scanning apparatus 110 according to the aspect of the embodiment are described.

FIG. 2 shows a diagram for explaining an effect of the light scanning apparatus 110 according to the aspect of the embodiment.

In FIG. 2, light emitting points 2101a and 2101b that are farthest from a center on opposite sides are shown among the plurality of light emitting points in the light source 1101.

Further, in FIG. 2, an arrow 2102 schematically illustrating the power of the anamorphic collimator lens 1102, namely the power of the incident optical system 145a is shown.

Furthermore, FIG. 2 shows a position 2103 of the deflecting surface of the deflecting unit 1, and a combination 2104 of a straight line and a curved line schematically illustrating a shape of the exit surface (first sagittal line tilt surface, first optical surface) of the first fθ lens 1106, namely the sagittal line tilt coefficient M₀₁ and the curvature radius R, respectively.

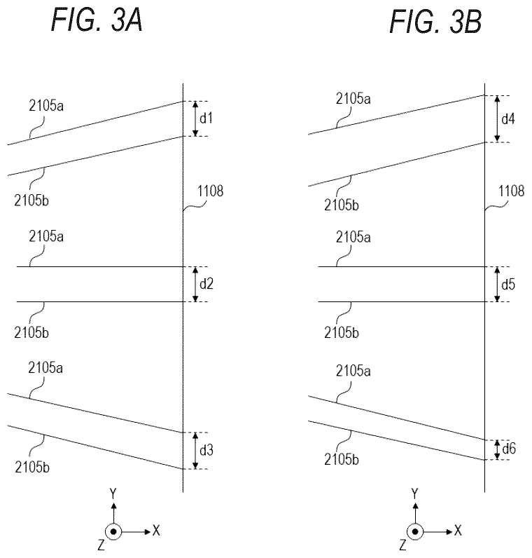

FIG. 3A schematically illustrates a state in which the light beams 2105a and 2105b emitted from the light emitting points 2101a and 2101b of the light source 1101 arrive at the positive side outermost off-axis image height, the on-axis image height, and the negative side outermost off-axis image height on the scanned surface 1108 when Δx/d=0.

FIG. 3B schematically illustrates a state in which the light beams 2105a and 2105b emitted from the light emitting points 2101a and 2101b of the light source 1101 arrive at the positive side outermost off-axis image height, the on-axis image height, and the negative side outermost off-axis image height on the scanned surface 1108 when Δx/d≠0.

Here, Δx (mm) represents a distance in a direction parallel to the optical axis between the arrival positions of the light beams 2105a and 2105b on the exit surface of the first fθ lens 1106, and d (mm) represents an interval in the sub-scanning direction between the light emitting point 2101a and the light emitting point 2101b.

Further, d1, d2 and d3 represent distances in the main scanning direction between the arrival positions of the light beam 2105a and 2105b at the positive side outermost off-axis image height, the on-axis image height, and the negative side outermost off-axis image height on the scanned surface 1108, respectively, when Δx/d is 0.

Furthermore, d4, d5, and d6 represent distances in the main scanning direction between the arrival positions of the light beam 2105a and 2105b at the positive side outermost off-axis image height, the on-axis image height, and the negative side outermost off-axis image height on the scanned surface 1108, respectively, when Δx/d is not 0.

As shown in FIG. 3A, when Δx/d is 0, a relationship of d1=d2=d3 is satisfied, namely a width of an image formed by the light beam 2105a and that of an image formed by the light beam 2105b on the scanned surface 1108 are equal to each other.

On the other hand, when Δx/d is not 0, a relationship of d4≠d5≠d6 is satisfied, namely a width of an image formed by the light beam 2105a and that of the image formed by the light beam 2105b on the scanned surface 1108 are different from each other.

In particular, when Δx/d is larger than 0, a relationship of d4>d5>d6 is satisfied as shown in FIG. 3B, namely a width of an image formed by the light beam 2105a is wider than that of the image formed by the light beam 2105b on the scanned surface 1108.

Here, a distance on the optical axis between the light source 1101 and the deflecting surface of the deflecting unit 1 is represented by L (mm), and a distance in the sub-scanning direction between a center of the light source 1101 and the light emitting point 2101a or the light emitting point 2101b is represented by d₀ (mm). That is, a relationship of d₀=d/2 is satisfied.

The position of the light source 1101 on the optical axis can be obtained as an intersection between a plane including the plurality of light emitting points provided in the light source 1101 and the optical axis.

Further, an angle formed by a straight line passing through the light emitting point 2101a or the light emitting point 2101b, and the center of the anamorphic collimator lens 1102 with respect to the optical axis in the sub-scanning cross section is represented by θ (degrees).

A lateral magnification of the anamorphic collimator lens 1102 in the sub-scanning cross section, namely the lateral magnification of the incident optical system 145a in the sub-scanning cross section is represented by β.

At this time, a height in the sub-scanning direction of the arrival position of the light beam 2105a or the light beam 2105b on the deflecting surface of the deflecting unit 1 is represented by −β×d₀, so that the following Expression (5) is obtained:

$$tan θ = \frac{( 1 - β ) {d}_{0}}{L} . \qquad ( 5 )$$

Next, the curvature radius in the sub-scanning cross section of the exit surface of the first fθ lens 1106 on the optical axis is represented by R (mm), and an eccentricity amount in the sub-scanning direction of the first fθ lens 1106 is represented by Lₛ (mm).

At this time, an inclination M at the arrival position of the light beam 2105a or the light beam 2105b on the exit surface of the first fθ lens 1106 can be approximately expressed by the following Expression (6) using the aspheric surface coefficient M₀₁ shown in the Expression (2) corresponding to the sagittal line tilt amount on the optical axis:

$$M = \frac{{L}_{s}}{R} + {M}_{01} . \qquad ( 6 )$$

The inclination M of the exit surface of the first fθ lens 1106 is defined as an inclination of a normal of the exit surface of the first fθ lens 1106 with respect to the optical axis.

Further, when a distance in the sub-scanning direction between the arrival positions of the light beam 2105a and the light beam 2105b on the exit surface of the first fθ lens 1106 is represented by Δy (mm), the following Expression (7) is obtained:

$$Δ x = M \times Δ y . \qquad ( 7 )$$

When a distance on the optical axis between the deflecting surface of the deflecting unit 1 and the exit surface of the first fθ lens 1106 is represented by D (mm), Δy can be expressed by the following Expression (8):

$$Δ y = 2 ( - β {d}_{0} + D tan θ ) = 2 {d}_{0} [ - β + \frac{( 1 - β ) D}{L} ] . \qquad ( 8 )$$

Note that Expression (5) is used when Expression (8) is derived.

Accordingly, Δx/d can be expressed by the following Expression (9) using Expressions (7) and (8):

$$\frac{Δ x}{d} = \frac{M \times Δ y}{2 {d}_{0}} = M [ - β + \frac{( 1 - β ) D}{L} ] . \qquad ( 9 )$$

Further, Equation (9) can be rewritten as the following Expression (10) by using Expression (6):

$$\frac{Δ x}{d} = [ \frac{{L}_{s}}{R} + {M}_{01} ] \times [ - β + \frac{( 1 - β ) D}{L} ] . \qquad ( 10 )$$

When a value of Δx/d is small, a difference between an inclination of a light beam incident on the first fθ lens 1106 and an inclination of the light beam exiting from the first fθ lens 1106 becomes small.

Therefore, a degree of freedom in an arrangement of the second fθ lens 1107 and the photosensitive drum 1108 is reduced, so that it is difficult to sufficiently reduce the size.

On the other hand, when the value of Δx/d is large, the light beams 2105a and 2105b emitted from the light emitting points 2101a and 2101b pass through such first fθ lens 1106, and thus the difference between the widths of the images formed by the light beams 2105a and 2105b becomes large as described above with reference to FIG. 3B.

Accordingly, in the light scanning apparatus 110 according to the aspect of the embodiment, both of downsizing and high definition be achieved by satisfying the following Inequality (11) for an absolute value of Δx/d.

In other words, in the light scanning apparatus 110 according to the aspect of the embodiment, the following Inequality (11) be satisfied for all of the light emitting points of the light source 1101:

$$0.05 < \vert M [ - β + \frac{( 1 - β ) D}{L} ] \vert < 0.7 . \qquad ( 11 )$$

In the light scanning apparatus 110 according to the aspect of the embodiment, the following Inequality (11a) be satisfied instead of Inequality (11) for all of the light emitting points of the light sources 1101:

$$0.1 < \vert M [ - β + \frac{( 1 - β ) D}{L} ] \vert < 0.65 . \qquad ( 11 a )$$

Further, in the light scanning apparatus 110 according to the aspect of the embodiment, the following Inequality (11b) be satisfied instead of Inequality (11a) for all the light emitting points of the light sources 1101:

$$0.15 < \vert M [ - β + \frac{( 1 - β ) D}{L} ] \vert < 0.6 . \qquad ( 11 b )$$

Note that the above-described effect can be obtained when Inequalities (11), (11a) and (11b) are satisfied for at least one of the light emitting points of the light sources 1101 although Inequalities (11), (11a) and (11b) are satisfied for all the light emitting points of the light sources 1101.

In addition, as an inclination amount of the exit surface of the first fθ lens 1106, namely the sagittal line tilt coefficient M₀₁ increases, the difference between the widths of the images formed by the light beams 2105a and 2105b increases.

Therefore, in the light scanning apparatus 110 according to the aspect of the embodiment, the following Inequality (12) be satisfied:

$$0 < \vert {M}_{01} [ - β + \frac{( 1 - β ) D}{L} ] \vert < 0.185 . \qquad ( 12 )$$

In addition, when the exit surface of the first fθ lens 1106 has a curvature, the inclination amounts at the arrival positions on the exit surface of the light beams emitted from the respective light emitting points of the light source 1101 is different from each other.

Therefore, in the light scanning apparatus 110 according to the aspect of the embodiment, the following Inequality (13) be satisfied:

$$0.05 < \vert [ \frac{{L}_{s}}{R} + {M}_{01} ] \times [ - β + \frac{( 1 - β ) D}{L} ] \vert < 0.7 . \qquad ( 13 )$$

Specifically, β is −3.65, D is 34.2 mm, Lis 161.7 mm, and M is −0.127 in the light scanning apparatus 110 according to the aspect of the embodiment.

Accordingly, the value of each of Inequalities (11), (11a) and (11b) is calculated as 0.589, so that Inequalities (11), (11a) and (11b) are satisfied.

On the other hand, in the light scanning apparatus 110 according to the aspect of the embodiment, since M₀₁ is −0.0918, the value of Inequality (12) is calculated as 0.426, so that Inequality (12) is not satisfied.

Further, in the light scanning apparatus 110 according to the aspect of the embodiment, since Lₛ is −1.45 mm and R is 41.166 mm, the value of Inequality (13) is calculated as 0.589, so that Inequality (13) is satisfied.

The sagittal line tilt amount of the exit surface of the first fθ lens 1106 provided in the light scanning apparatus 110 according to the aspect of the embodiment varies according to the position in the main scanning direction.

Then, an absolute value of the sagittal line tilt amount of the exit surface of the first fθ lens 1106 is the largest on the optical axis.

Further, the first fθ lens 1106 has a positive power in the sub-scanning cross section.

Further, the first fθ lens 1106 closest to the deflecting unit 1 on the optical path of the light flux LG among the fθ lenses included in the scanning optical system 145b, is an fθ lens having the strongest power in the main scanning cross section among the fθ lenses included in the scanning optical system 145b.

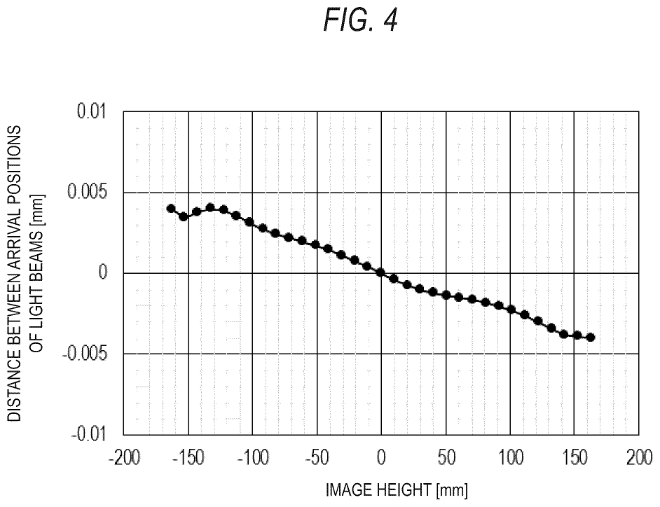

FIG. 4 shows distances in the main scanning direction between the arrival positions of the light beams 2105a and 2105b at respective image heights on the scanned surface 1108 in the light scanning apparatus 110 according to the aspect of the embodiment.

That is, the distances include d4, d5 and d6 shown in FIG. 3B, and the distance at the on-axis image height is shown as 0 mm in FIG. 4.

As shown in FIG. 4, in the light scanning apparatus 110 according to the aspect of the embodiment, a difference between a maximum value and a minimum value of the distances is 8.0 μm.

Since the difference corresponds to a deviation of about 9.4% with respect to 300 dpi, namely a pitch of 84.7 μm, an influence of the deviation of the arrival position of each light beam on the scanned surface 1108 on the image quality can be reduced.

As described above, in the light scanning apparatus 110 according to the aspect of the embodiment, it is possible to suppress a deterioration of the image quality due to the deviation of the arrival position of each light beam on the scanned surface 1108 by satisfying Inequality (11).

In addition, in the light scanning apparatus 110 according to the aspect of the embodiment, it is possible to achieve downsizing by forming the exit surface of the first fθ lens 1106 as a sagittal line tilt surface.

### Second Embodiment

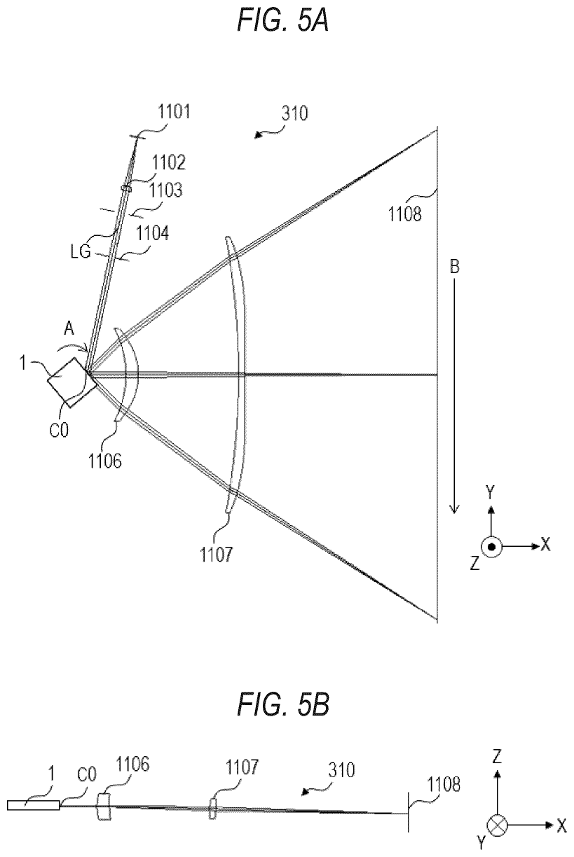

FIGS. 5A and 5B show a schematic main scanning cross sectional view and a schematic partial sub-scanning cross sectional view of a light scanning apparatus 310 according to a second embodiment of the disclosure, respectively.

The light scanning apparatus 310 according to the aspect of the embodiment has the same configuration as the light scanning apparatus 110 according to the first embodiment except that the specification values are different, so that the same members are denoted by the same reference numerals, and description thereof is omitted.

Specifically, various characteristics of the incident optical system 145a and the scanning optical system 145b provided in the light scanning apparatus 310 according to the aspect of the embodiment are shown in the following Tables 3 and 4, respectively.

TABLE 3
Characteristics of light source 1101

| | | |
|---|---|---|
| Wavelength | λ(nm) | 790 |
| Incident polarization to deflecting | | p |
| surface of deflecting unit 1 | | polarization |
| Full angle at half maximum in main | FFPy(deg) | 12.00 |
| scanning direction | | |
| Full angle at half maximum in sub- | FFPz(deg) | 30.00 |
| scanning direction | | |

Shape of stop

| | Main scanning | Sub-scanning |
|---|---|---|
| | direction | direction |
| Sub-scanning stop 1103 | 10.000 | 2.840 |
| Main scanning stop 1104 | 3.750 | — |

Refractive index

| | | |
|---|---|---|
| Anamorphic collimator lens 1102 | N1 | 1.5282 |

Shape of optical element

| | | Main | Sub- |
|---|---|---|---|
| | | scanning | scanning |
| | | direction | direction |
| Curvature radius of incident | r1a (mm) | ∞ | ∞ |
| surface of anamorphic collimator | | | |
| lens 1102 | | | |
| Curvature radius of exit | r1b (mm) | −37.169 | −26.170 |
| surface of anamorphic collimator | | | |
| lens 1102 | | | |
| Phase coefficient of incident | D2, 0 | −7.847E−03 | — |
| surface of anamorphic collimator | D0, 2 | — | −8.669E−03 |
| lens 1102 | | | |

Focal length

| | | Main scanning | Sub-scanning |
|---|---|---|---|
| | | direction | direction |
| Anamorphic collimator lens 1102 | fcol | 33.94 | 27.15 |
| | (mm) | | |

Arrangement

| | | |
|---|---|---|
| Light source 1101 - | d0 | 33.59 |
| Incident surface of anamorphic collimator lens 1102 | (mm) | |
| Incident surface of anamorphic collimator lens 1102 - | d1 | 3.00 |
| Exit surface of anamorphic collimator lens 1102 | (mm) | |
| Exit surface of anamorphic collimator lens 1102 - | d2 | 15.15 |
| Sub-scanning stop 1103 | (mm) | |
| Sub-scanning stop 1103 - | d4 | 29.87 |
| Main scanning stop 1104 | (mm) | |
| Main scanning stop 1104 - | d5 | 80.09 |
| Deflecting surface of deflecting unit 1 | (mm) | |
| Incident angle in main scanning cross section of light | A1 | 78.00 |
| flux exiting from main scanning stop 1104 to | (deg) | |
| deflecting surface | | |
| Incident angle in sub-scanning cross section of light | A2 | −3.00 |
| flux exiting from main scanning stop 1104 to | (deg) | |
| deflecting surface | | |

TABLE 4
fθ coefficient, Scanning width, Maximum angle of view

| | | |
|---|---|---|
| fθ coefficient | k (mm/rad) | 207 |
| Scanning width | W (mm) | 330 |
| Maximum angle of view | θ(deg) | 45.7 |

Refractive index

| | | |
|---|---|---|
| Refractive index of first fθ lens 1106 | N5 | 1.5281915 |
| Refractive index of second fθ lens 1107 | N6 | 1.5281915 |

Deflecting unit 1

| | | |
|---|---|---|
| Number of deflecting surfaces | | 4 |
| Circumscribed radius | Rpol (mm) | 10 |
| Rotation center - Deflection reference | Xpol (mm) | 6.03 |
| point C0 (Optical axis direction) | | |
| Rotation center - Deflection reference | Ypol (mm) | 3.79 |
| point C0 (main scanning direction) | | |

Arrangement in scanning optical system 145b

| | | |
|---|---|---|
| Deflection reference point C0 - | d12 (mm) | 26.00 |
| Incident surface of first fθ lens 1106 | | |
| Incident surface of first fθ lens 1106 - | d13 (mm) | 8.20 |
| Exit surface of first fθ lens 1106 | | |
| Exit surface of first fθ lens 1106 - | d14 (mm) | 66.60 |
| Incident surface of second fθ lens 1107 | | |
| Incident surface of second fθ lens 1107 - | d15 (mm) | 4.30 |
| Exit surface of second fθ lens 1107 | | |
| Exit surface of second fθ lens 1107 - | d16 (mm) | 127.90 |
| Scanned surface 1108 | | |
| Deflection reference point C0 - | L1 (mm) | 26.00 |
| Incident surface of first fθ lens 1106 | | |
| Deflection reference point C0 - | L2 (mm) | 100.80 |
| Incident surface of second fθ lens 1107 | | |
| Deflection reference point C0 - | T2 (mm) | 233.00 |
| Scanned surface 1108 | | |
| Sub-scanning eccentricity of second fθ | shiftZ | −1.37 |
| lens 1107 | (mm) | |

| Meridional line shape of | | | Meridional line shape of | | |
|---|---|---|---|---|---|
| first fθ lens 1106 | | | first fθ lens 1107 | | |
| | Incident | | | Incident | |
| | surface | Exit surface | | surface | Exit surface |
| | Opposite | Opposite | | Opposite | Opposite |
| | light | light | | light | light |
| | source side | source side | | source side | source side |
| R | −66.242 | −40.841 | R | −494.7832 | 802.295 |
| ku | 8.020E−01 | −5.277E−01 | ku | 0 | −6.789E+02 |
| B4u | −2.796E−06 | −1.602E−06 | B4u | 0 | −2.895E−07 |
| B6u | 8.876E−09 | 1.735E−09 | B6u | 0 | 2.255E−11 |
| B8u | −7.979E−12 | 1.355E−12 | B8u | 0 | −1.522E−15 |
| B10u | 2.370E−15 | −1.715E−15 | B10u | 0 | 4.450E−20 |
| B12u | 0 | 0 | B12u | 0 | 0.000E+00 |
| | Light source | Light source | | Light source | Light source |
| | side | side | | side | side |
| k1 | 8.020E−01 | −5.277E−01 | k1 | 0 | −6.789E+02 |
| B41 | −2.796E−06 | −1.602E−06 | B41 | 0 | −2.895E−07 |
| B61 | 8.876E−09 | 1.735E−09 | B61 | 0 | 2.255E−11 |
| B81 | −7.979E−12 | 1.355E−12 | B81 | 0 | −1.522E−15 |
| B101 | 2.370E−15 | −1.715E−15 | B101 | 0 | 4.450E−20 |
| B121 | 0 | 0 | B121 | 0 | 0.000E+00 |

| Sagittal line shape of | | | Sagittal line shape of | | |
|---|---|---|---|---|---|
| first fθ lens 1106 | | | first fθ lens 1107 | | |
| | Incident | | | Incident | |
| | surface | Exit surface | | surface | Exit surface |
| | Sagittal line | Sagittal line | | Sagittal line | Sagittal line |
| | R change | R change | | R change | R change |
| r | 50.000 | 76.858 | r | 46.640 | −79.14512 |
| E1 | 0 | 0 | E1 | 0.000E+00 | −1.460E−06 |
| E2 | 0 | 2.018E−05 | E2 | −1.990E−06 | 3.054E−07 |
| E3 | 0 | 0 | E3 | 0 | −1.037E−09 |
| E4 | 0 | −1.126E−08 | E4 | 0.000E+00 | −2.859E−10 |
| E5 | 0 | 0 | E5 | 0 | 7.163E−13 |
| E6 | 0 | 6.930E−11 | E6 | 0.000E+00 | 1.866E−14 |
| E7 | 0 | 0 | E7 | 0 | −1.675E−16 |
| E8 | 0 | −2.386E−14 | E8 | 0.000E+00 | −1.281E−19 |
| E9 | 0 | 0 | E9 | 0 | 1.2395E−20 |
| E10 | 0 | −7.962E−17 | E10 | 0 | −4.877E−23 |
| | Sagittal line | Sagittal line | | Sagittal line | Sagittal line |
| | tilt | tilt | | tilt | tilt |
| M0_1 | 0 | −3.850E−02 | M0_1 | 8.966E−02 | 7.878E−02 |
| M1_1 | 0 | 0 | M1_1 | −3.516E−06 | −2.624E−06 |
| M2_1 | 0 | −4.057E−05 | M2_1 | −2.739E−05 | −2.545E−05 |
| M3_1 | 0 | 0 | M3_1 | 6.075E−08 | 5.025E−08 |
| M4_1 | 0 | 0 | M4_1 | 5.534E−09 | 6.347E−09 |
| M5_1 | 0 | 0 | M5_1 | −3.749E−11 | −2.803E−11 |
| M6_1 | 0 | 0 | M6_1 | −2.101E−13 | −8.019E−13 |
| M7_1 | 0 | 0 | M7_1 | 7.252E−15 | 4.725E−15 |
| M8_1 | 0 | 0 | M8_1 | −5.256E−17 | 7.298E−17 |
| M9_1 | 0 | 0 | M9_1 | −4.108E−19 | −2.157E−19 |
| M10_1 | 0 | 0 | M10_1 | 2.174E−21 | −5.879E−21 |
| M11_1 | 0 | 0 | M11_1 | 0 | 0 |
| M12_1 | 0 | 0 | M12_1 | 0 | 0 |

In Tables 3 and 4, an optical axis, an axis orthogonal to the optical axis in the main scanning cross section, and an axis orthogonal to the optical axis in the sub-scanning cross section are defined as an X-axis, a Y-axis, and a Z-axis, respectively, when an intersection between each lens surface and the optical axis is defined as an origin.

Further, in Table 4, “E-x” means “×10^{-x}”.

An aspheric surface shape (meridional line shape) in the main scanning cross section of each lens surface of the first fθ lens 1106 and the second fθ lens 1107 provided in the light scanning apparatus 310 according to the aspect of the embodiment is represented by the above-described Expression (1).

An aspheric surface shape (sagittal line shape) in the sub-scanning cross section of each lens surface of the first fθ lens 1106 and the second fθ lens 1107 provided in the light scanning apparatus 310 according to the aspect of the embodiment is represented by the above-described Expression (2).

A curvature radius r′ in the sub-scanning cross section of each lens surface of the first fθ lens 1106 and the second fθ lens 1107 provided in the light scanning apparatus 310 according to the aspect of the embodiment continuously varies in accordance with a position in the Y direction as represented by the above-described Expression (3).

The anamorphic collimator lens 1102 provided in the light scanning apparatus 310 according to the aspect of the embodiment has an incident surface formed by a diffracting surface defined by the optical path difference function of two variables Y and Z as represented by the above-described Expression (4).

Further, in the light scanning apparatus 310 according to the aspect of the embodiment, Inequality (11) be satisfied, Inequality (11a) be satisfied, and Inequality (11b) be satisfied.

In the light scanning apparatus 310 according to the aspect of the embodiment, Inequalities (12) and (13) be satisfied.

Specifically, in the light scanning apparatus 310 according to the aspect of the embodiment, β is −3.65, D is 34.2 mm, Lis 161.7 mm, and M is −0.0385.

Therefore, a value of each of Inequalities (11), (11a) and (11b) is calculated as 0.179, so that Inequalities (11), (11a) and (11b) are satisfied.

Further, in the light scanning apparatus 310 according to the aspect of the embodiment, since M₀₁ is −0.0385, a value of Inequality (12) is calculated as 0.179, so that Inequality (12) is satisfied.

Furthermore, in the light scanning apparatus 310 according to the aspect of the embodiment, since Lₛ is 0 mm and R is 76.858 mm, a value of Inequality (13) is calculated as 0.179, so that Inequality (13) is satisfied.

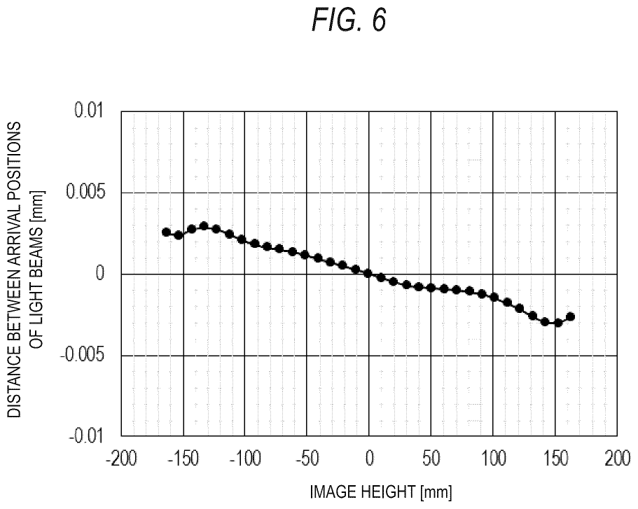

FIG. 6 shows distances in the main scanning direction between arrival positions of light beams 2105a and 2105b at respective image heights on the scanned surface 1108 in the light scanning apparatus 310 according to the aspect of the embodiment.

That is, the distances include d4, d5, and d6 shown in FIG. 3B, and the distance at the on-axis image height is shown as 0 mm in FIG. 6.

As shown in FIG. 6, in the light scanning apparatus 310 according to the aspect of the embodiment, a difference between a maximum value and a minimum value of the distances is 5.9 μm.

Since the difference corresponds to a deviation of about 7.0% with respect to 300 dpi, namely a pitch of 84.7 μm, an influence of the deviation of the arrival position of each light beam on the scanned surface 1108 on the image quality can be reduced. As described above, in the light scanning apparatus 310 according to the aspect of the embodiment, it is possible to suppress a deterioration of the image quality due to the deviation of the arrival position of each light beam on the scanned surface 1108 by satisfying Inequality (11).

### Third Embodiment

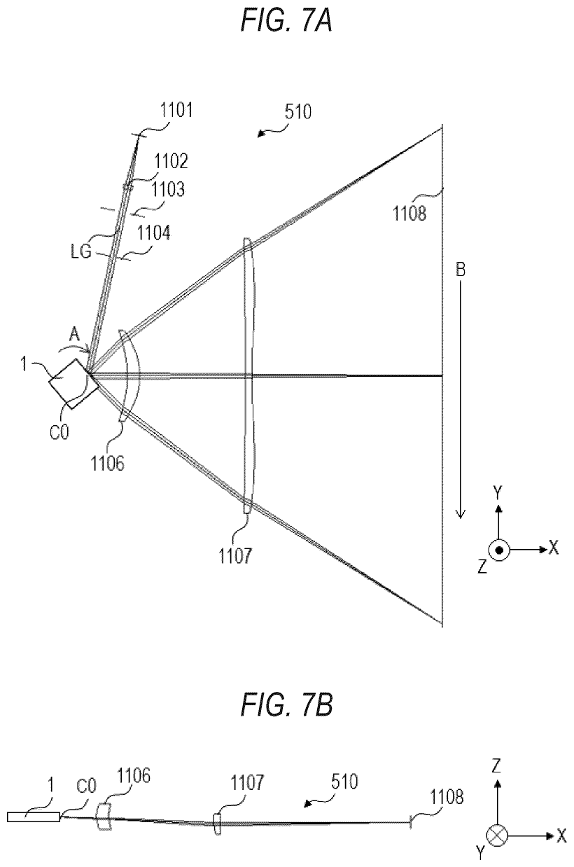

FIGS. 7A and 7B show a schematic main scanning cross sectional view and a schematic partial sub-scanning cross sectional view of a light scanning apparatus 510 according to a third embodiment of the disclosure, respectively.

The light scanning apparatus 510 according to the aspect of the embodiment has the same configuration as the light scanning apparatus 110 according to the first embodiment except that the specification values are different, so that the same members are denoted by the same reference numerals, and description thereof is omitted.

Specifically, various characteristics of the incident optical system 145a and the scanning optical system 145b provided in the light scanning apparatus 510 according to the aspect of the embodiment are shown in the following Tables 5 and 6, respectively.

TABLE 5
Characteristics of light source 1101

| | | |
|---|---|---|
| Wavelength | λ(nm) | 790 |
| Incident polarization to deflecting surface | | p |
| of deflecting unit 1 | | polarization |
| Full angle at half maximum in main | FFPy(deg) | 12.00 |
| scanning direction | | |
| Full angle at half maximum in sub- | FFPz(deg) | 30.00 |
| scanning direction | | |

Shape of stop

| | Main scanning | Sub-scanning |
|---|---|---|
| | direction | direction |
| Sub-scanning stop 1103 | 10.000 | 2.840 |
| Main scanning stop 1104 | 3.750 | — |

Refractive index

| | | |
|---|---|---|
| Anamorphic collimator lens 1102 | N1 | 1.5282 |

Shape of optical element

| | | Main scanning | Sub-scanning |
|---|---|---|---|
| | | direction | direction |
| Curvature radius of incident surface | r1a (mm) | ∞ | ∞ |
| of anamorphic collimator lens 1102 | | | |
| Curvature radius of exit surface | r1b (mm) | −37.169 | −26.170 |
| of anamorphic collimator lens 1102 | | | |
| Phase coefficient of incident surface | D2, 0 | −7.847E-03 | — |
| of anamorphic collimator lens 1102 | D0, 2 | — | −8.669E-03 |

Focal length

| | | Main | Sub- |
|---|---|---|---|
| | | scanning | scanning |
| | | direction | direction |
| Anamorphic collimator lens 1102 | fcol | 33.94 | 27.15 |
| | (mm) | | |

Arrangement

| | | |
|---|---|---|
| Light source 1101 - Incident surface of | d0 | 33.59 |
| anamorphic collimator lens 1102 | (mm) | |
| Incident surface of anamorphic collimator | d1 | 3.00 |
| lens 1102 - Exit surface of anamorphic | (mm) | |
| collimator lens 1102 | | |
| Exit surface of anamorphic collimator | d2 | 15.15 |
| lens 1102 - Sub-scanning stop 1103 | (mm) | |
| Sub-scanning stop 1103 - | d4 | 29.87 |
| Main scanning stop 1104 | (mm) | |
| Main scanning stop 1104 - | d5 | 80.09 |
| Deflecting surface of deflecting unit 1 | (mm) | |
| Incident angle in main scanning cross section | A1 | 78.00 |
| of light flux exiting from main scanning stop | (deg) | |
| 1104 to deflecting surface | | |
| Incident angle in sub-scanning cross section | A2 | −3.00 |
| of light flux exiting from main scanning stop | (deg) | |
| 1104 to deflecting surface | | |

TABLE 6
fθ coefficient, Scanning width, Maximum angle of view

| | | |
|---|---|---|
| fθ coefficient | k (mm/rad) | 207 |
| Scanning width | W (mm) | 330 |
| Maximum angle of view | θ(deg) | 45.7 |

Refractive index

| | | |
|---|---|---|
| Refractive index of first fθ lens 1106 | N5 | 1.5281915 |
| Refractive index of second fθ lens 1107 | N6 | 1.5281915 |

Deflecting unit 1

| | | |
|---|---|---|
| Number of deflecting surfaces | | 4 |
| Circumscribed radius | Rpol (mm) | 10 |
| Rotation center - Deflection reference | Xpol (mm) | 6.03 |
| point C0 (Optical axis direction) | | |
| Rotation center - Deflection reference | Ypol (mm) | 3.79 |
| point C0 (main scanning direction) | | |

Arrangement in scanning optical system 145b

| | | |
|---|---|---|
| Deflection reference point C0 - | d12 (mm) | 26.00 |
| Incident surface of first fθ lens 1106 | | |
| Incident surface of first fθ lens 1106 - | d13 (mm) | 8.20 |
| Exit surface of first fθ lens 1106 | | |
| Exit surface of first fθ lens 1106 - | d14 (mm) | 69.30 |
| Incident surface of second fθ lens 1107 | | |
| Incident surface of second fθ lens 1107 - | d15 (mm) | 4.30 |
| Exit surface of second fθ lens 1107 | | |
| Exit surface of second fθ lens 1107 - | d16 (mm) | 125.20 |
| Scanned surface 1108 | | |
| Deflection reference point C0 - | L1 (mm) | 26.00 |
| Incident surface of first fθ lens 1106 | | |
| Deflection reference point C0 - | L2 (mm) | 103.50 |
| Incident surface of second fθ lens 1107 | | |
| Deflection reference point C0 - | T2 (mm) | 233.00 |
| Scanned surface 1108 | | |
| Sub-scanning eccentricity of | shiftZ (mm) | −5.03 |
| second fθ lens 1107 | | |

| Meridional line shape of | | | Meridional line shape of | | |
|---|---|---|---|---|---|
| first fθ lens 1106 | | | first fθ lens 1107 | | |
| | Incident | | | Incident | |
| | surface | Exit surface | | surface | Exit surface |
| | Opposite light | Opposite light | | Opposite light | Opposite light |
| | source side | source side | | source side | source side |
| R | −71.101 | −42.946 | R | −4000 | 350.123 |
| ku | 9.464E−01 | −5.155E−01 | ku | 0 | −8.753E+01 |
| B4u | −9.147E−07 | −3.477E−07 | B4u | 0 | −2.020E−07 |
| B6u | 6.784E−09 | 1.690E−09 | B6u | 0 | 1.609E−11 |
| B8u | −5.767E−12 | 1.110E−12 | B8u | 0 | −9.313E−16 |
| B10u | 1.638E−15 | −1.224E−15 | B10u | 0 | 2.524E−20 |
| B12u | 0 | 0 | B12u | 0 | 0.000E+00 |
| | Light source | Light source | | Light source | Light source |
| | side | side | | side | side |
| k1 | 9.464E−01 | −5.155E−01 | k1 | 0 | −8.753E+01 |
| B41 | −9.147E−07 | −3.477E−07 | B41 | 0 | −2.020E−07 |
| B61 | 6.784E−09 | 1.690E−09 | B61 | 0 | 1.609E−11 |
| B81 | −5.767E−12 | 1.110E−12 | B81 | 0 | −9.313E−16 |
| B101 | 1.638E−15 | −1.224E−15 | B101 | 0 | 2.524E−20 |
| B121 | 0 | 0 | B121 | 0 | 0.000E+00 |

| Sagittal line shape of | | | Sagittal line shape of | | |
|---|---|---|---|---|---|
| first fθ lens 1106 | | | second fθ lens 1107 | | |
| | Incident | | | Incident | |
| | surface | Exit surface | | surface | Exit surface |
| | Sagittal line | Sagittal line | | Sagittal line | Sagittal line |
| | R change | R change | | R change | R change |
| r | 20.000 | 25.004 | r | 37.079 | −154.0078 |
| E1 | 0 | 0 | E1 | 0.000E+00 | −1.278E−07 |
| E2 | 0 | 1.522E−05 | E2 | −7.458E−07 | 1.813E−06 |
| E3 | 0 | 0 | E3 | 0 | −3.240E−09 |
| E4 | 0 | 8.486E−10 | E4 | 0.000E+00 | −3.041E−10 |
| E5 | 0 | 0 | E5 | 0 | 1.339E−12 |
| E6 | 0 | −2.508E−11 | E6 | 0.000E+00 | 3.082E−14 |
| E7 | 0 | 0 | E7 | 0 | −2.009E−16 |
| E8 | 0 | 7.607E−15 | E8 | 0.000E+00 | −1.954E−18 |
| E9 | 0 | 0 | E9 | 0 | 9.85865E−21 |
| E10 | 0 | 1.610E−17 | E10 | 0 | 5.812E−23 |
| | Sagittal line | Sagittal line | | Sagittal line | Sagittal line |
| | tilt | tilt | | tilt | tilt |
| M0_1 | 0 | −2.124E−02 | M0_1 | −1.007E−01 | 2.315E−02 |
| M1_1 | 0 | 0 | M1_1 | −2.129E−04 | −2.002E−04 |
| M2_1 | 0 | 3.321E−05 | M2_1 | −1.314E−05 | −2.370E−05 |
| M3_1 | 0 | 0 | M3_1 | 1.161E−07 | 1.056E−07 |
| M4_1 | 0 | 0 | M4_1 | 1.765E−09 | 3.675E−09 |
| M5_1 | 0 | 0 | M5_1 | −1.616E−11 | −1.409E−11 |
| M6_1 | 0 | 0 | M6_1 | 3.014E−13 | −3.052E−13 |
| M7_1 | 0 | 0 | M7_1 | 1.061E−15 | 9.733E−16 |
| M8_1 | 0 | 0 | M8_1 | −1.306E−17 | 6.574E−17 |
| M9_1 | 0 | 0 | M9_1 | −1.657E−20 | −1.728E−20 |
| M10_1 | 0 | 0 | M10_1 | −8.536E−22 | −3.960E−21 |
| M11_1 | 0 | 0 | M11_1 | 0 | 0 |
| M12_1 | 0 | 0 | M12_1 | 0 | 0 |

In Tables 5 and 6, an optical axis, an axis orthogonal to the optical axis in the main scanning cross section, and an axis orthogonal to the optical axis in the sub-scanning cross section are defined as an X-axis, a Y-axis, and a Z-axis, respectively, when an intersection between each lens surface and the optical axis is defined as an origin.

Further, in Table 6, “E-x” means “×10^{-x}”.

An aspheric surface shape (meridional line shape) in the main scanning cross section of each lens surface of the first fθ lens 1106 and the second fθ lens 1107 provided in the light scanning apparatus 510 according to the aspect of the embodiment is represented by the above-described Expression (1).

An aspheric surface shape (sagittal line shape) in the sub-scanning cross section of each lens surface of the first fθ lens 1106 and the second fθ lens 1107 provided in the light scanning apparatus 510 according to the aspect of the embodiment is represented by the above-described Expression (2).

A curvature radius r′ in the sub-scanning cross section of each lens surface of the first fθ lens 1106 and the second fθ lens 1107 provided in the light scanning apparatus 510 according to the aspect of the embodiment continuously varies in accordance with a position in the Y direction as represented by the above-described Expression (3).

The anamorphic collimator lens 1102 provided in the light scanning apparatus 510 according to the aspect of the embodiment has an incident surface formed by a diffracting surface defined by the optical path difference function of two variables Y and Z as represented by the above-described Expression (4).

Further, in the light scanning apparatus 510 according to the aspect of the embodiment, Inequality (11) be satisfied, Inequality (11a) be satisfied, and Inequality (11b) be satisfied.

In the light scanning apparatus 510 according to the aspect of the embodiment, Inequalities (12) and (13) be satisfied.

Specifically, in the light scanning apparatus 510 according to the aspect of the embodiment, β is −3.65, D is 34.2 mm, Lis 161.7 mm, and M is −0.0735.

Therefore, a value of each of Inequalities (11), (11a) and (11b) is calculated as 0.341, and Inequalities (11), (11a) and (11b) are satisfied.

Further, in the light scanning apparatus 510 according to the aspect of the embodiment, since M₀₁ is −0.0212, a value of Inequality (12) is calculated as 0.098, so that Inequality (12) is satisfied.

Furthermore, in the light scanning apparatus 510 according to the aspect of the embodiment, since Lₛ is −1.31 mm and R is 25.004 mm, a value of Inequality (13) is calculated as 0.341, so that Inequality (13) is satisfied.

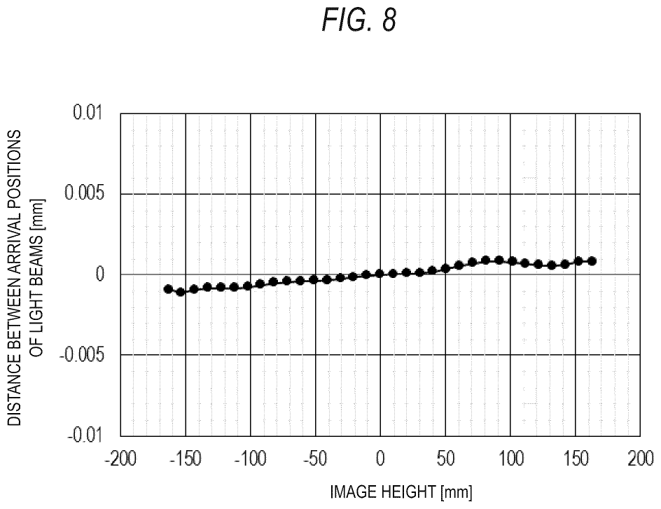

FIG. 8 shows distances in the main scanning direction between arrival positions of light beams 2105a and 2105b at respective image heights on the scanned surface 1108 in the light scanning apparatus 510 according to the aspect of the embodiment.

That is, the distances include d4, d5 and d6 shown in FIG. 3B, and the distance at the on-axis image height is shown as 0 mm in FIG. 8.

As shown in FIG. 8, in the light scanning apparatus 510 according to the aspect of the embodiment, a difference between a maximum value and a minimum value of the distances is 2.0 μm.

Then, the difference corresponds to a deviation of about 9.2% with respect to the 1200 dpi, namely a pitch of 21.2 μm, and a deviation of about 2.3% with respect to 300 dpi, namely a pitch of 84.7 μm.

Therefore, an influence of the deviation of the arrival position of each light beam on the scanned surface 1108 on the image quality can be reduced.

As described above, in the light scanning apparatus 510 according to the aspect of the embodiment, it is possible to suppress a deterioration of the image quality due to the deviation of the arrival position of each light beam on the scanned surface 1108 by satisfying Inequality (11).

### Fourth Embodiment

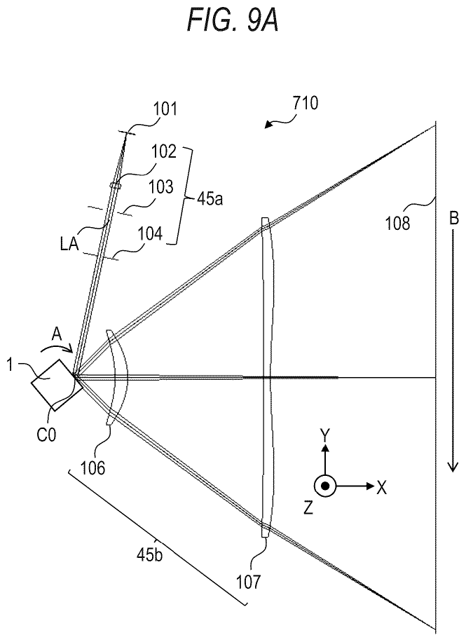

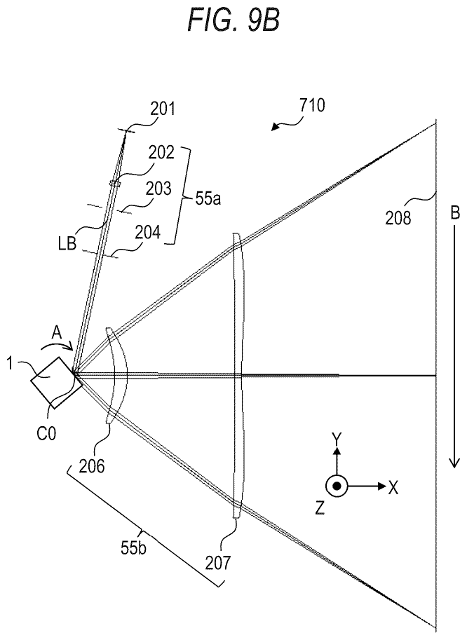

Each of FIGS. 9A and 9B shows a schematic partially developed view in the main scanning cross section of a light scanning apparatus 710 according to a fourth embodiment of the disclosure.

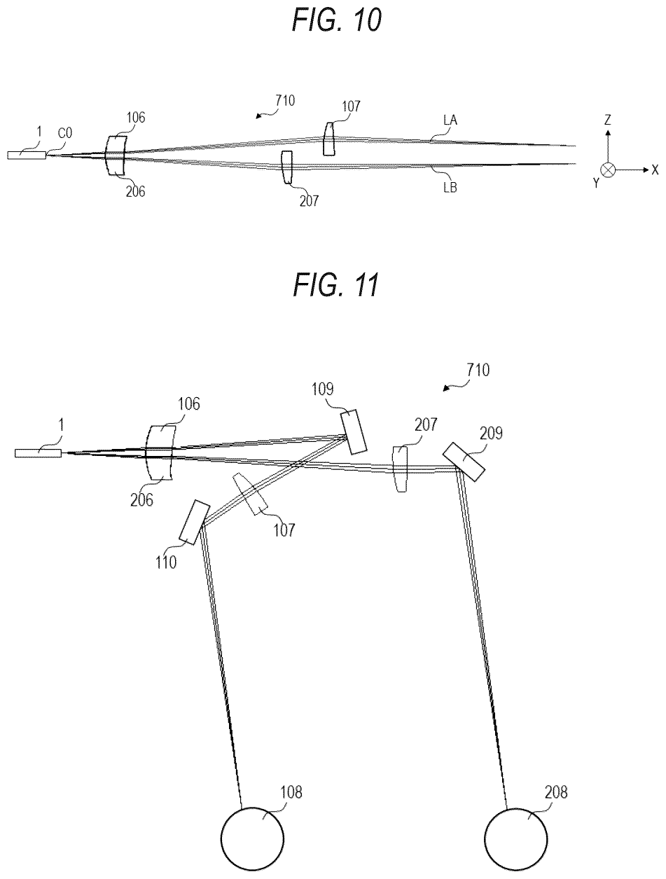

FIGS. 10 and 11 show a schematic partial developed view in the sub-scanning cross section and a schematic partial sub-scanning cross sectional view of the light scanning apparatus 710 according to the fourth embodiment, respectively.

The light scanning apparatus 710 according to the aspect of the embodiment includes first and second light sources 101 and 201, first and second anamorphic collimator lenses 102 and 202, and first and second sub-scanning stops 103 and 203.

Further, the light scanning apparatus 710 according to the aspect of the embodiment includes first and second main scanning stops 104 and 204, a deflecting unit 1, first fθ lenses 106 and 206, and second fθ lenses 107 and 207.

On optical paths, the first fθ lens 106 is arranged between the deflecting unit 1 and the second fθ lens 107, and the first fθ lens 206 is arranged between the deflecting unit 1 and the second fθ lens 207.

As each of the first and second light sources 101 and 201, a semiconductor laser (multibeam laser) or the like having a plurality of light emitting points is used.

The first and second anamorphic collimator lenses 102 and 202 convert light fluxes LA and LB emitted from the first and second light sources 101 and 201 into parallel light fluxes in the main scanning cross section, respectively, and condense the light fluxes LA and LB in the sub-scanning cross section, respectively. The parallel light flux includes not only a strictly parallel light flux but also a substantially parallel light flux such as a weakly divergent light flux or a weakly convergent light flux.

The first and second sub-scanning stops 103 and 203 limit light flux diameters in the sub-scanning direction of the light fluxes LA and LB that have passed through the first and second anamorphic collimator lenses 102 and 202, respectively.

The first and second main scanning stops 104 and 204 limit light flux diameters in the main scanning direction of the light fluxes LA and LB that have passed through the first and second sub-scanning stops 103 and 203, respectively.

In this way, the light fluxes LA and LB emitted from the first and second light sources 101 and 201 are condensed in the sub-scanning direction in the vicinity of a first deflecting surface of the deflecting unit 1, thereby line images elongated in the main scanning direction are formed.

The deflecting unit 1 deflects the incident light fluxes LA and LB with rotating by a driving unit such as a motor (not shown) in a direction indicated by an arrow A in FIGS. 9A and 9B. The deflecting unit 1 is formed by a polygon mirror, for example.

The first fθ lens 106 (first optical element, first imaging optical element) and the second fθ lens 107 are anamorphic imaging lenses having different powers between the main scanning cross section and the sub-scanning cross section, and condense (guide) the light flux LA deflected by the first deflecting surface of the deflecting unit 1 onto the first scanned surface 108.

The first fθ lens 206 (second optical element, second imaging optical element) and the second fθ lens 207 are anamorphic imaging lenses having different powers between the main scanning cross section and the sub-scanning cross section, and condense (guide) the light flux LB deflected by the first deflecting surface of the deflecting unit 1 onto the second scanned surface 208.

In the light scanning apparatus 710 according to the aspect of the embodiment, a first incident optical system 45a is formed by the first anamorphic collimator lens 102, the first sub-scanning stop 103 and the first main scanning stop 104.

A second incident optical system 55a is formed by the second anamorphic collimator lens 202, the second sub-scanning stop 203 and the second main scanning stop 204.

Further, in the light scanning apparatus 710 according to the aspect of the embodiment, a first scanning optical system 45b is formed by the first fθ lens 106 and the second fθ lens 107.

A second scanning optical system 55b is formed by the first fθ lens 206 and the second fθ lens 207.

Note that the refractive powers in the sub-scanning cross section of the second fθ lenses 107 and 207 are stronger than the refractive powers in the sub-scanning cross section of the first fθ lenses 106 and 206, namely the strongest among the first and second scanning optical systems 45b and 55b, respectively.

The light fluxes LA emitted from the respective light emitting points of the first light source 101 pass through the first incident optical system 45a to be incident on the first deflecting surface of the deflecting unit 1.

Then, the light fluxes LA incident on the first deflecting surface of the deflecting unit 1 from the first light source 101 are deflected by the first deflecting surface of the deflecting unit 1 to be guided onto the first scanned surface 108 by the first scanning optical system 45b, thereby the first scanned surface 108 is scanned at a constant speed.

The light fluxes LB emitted from the respective light emitting points of the second light source 201 pass through the second incident optical system 55a to be incident on the first deflecting surface of the deflecting unit 1.

Then, the light fluxes LB incident on the first deflecting surface of the deflecting unit 1 from the second light source 201 are deflected by the first deflecting surface of the deflecting unit 1 to be guided onto the second scanned surface 208 by the second scanning optical system 55b, thereby the second scanned surface 208 is scanned at a constant speed.

Since the deflecting unit 1 rotates in the direction indicated by the arrow A in FIGS. 9A and 9B, the light fluxes LA and LB deflected by the deflecting unit 1 scan the first and second scanned surfaces 108 and 208 in a direction indicated by an arrow B in FIGS. 9A and 9B, respectively.

In FIG. 9A and FIG. 9B, CO represents a deflection point (on-axis deflection point) on the first deflecting surface of the deflecting unit 1 with respect to a principal ray of an on-axis light flux. The deflection point CO serves as a reference point for the first and second scanning optical systems 45b and 55b.

In the aspect of the embodiment, first and second photosensitive drums 108 and 208 are used as the first and second scanned surfaces 108 and 208.

Exposure distributions in the sub-scanning direction on the first and second photosensitive drums 108 and 208 are formed by rotating the first and second photosensitive drums 108 and 208 in the sub-scanning direction for each main scanning exposure.

Next, various characteristics of the first and second incident optical systems 45a and 55a and the first and second scanning optical systems 45b and 55b provided in the light scanning apparatus 710 according to the aspect of the embodiment are shown in the following Tables 7 to 9.

TABLE 7
Characteristics of first and second light sources 101 and 102

| | | |
|---|---|---|
| Wavelength | λ(nm) | 790 |
| Incident polarization to first deflecting | | p |
| surface of deflecting unit 1 | | polarization |
| Full angle at half maximum in main | FFPy(deg) | 12.00 |
| scanning direction | | |
| Full angle at half maximum in sub- | FFPz(deg) | 30.00 |
| scanning direction | | |

Shape of stop

| | Main scanning | Sub-scanning |
|---|---|---|
| | direction | direction |
| First and second sub-scanning stops | 10.000 | 2.840 |
| 103 and 203 | | |
| First and second main scanning stops | 3.750 | — |
| 104 and 204 | | |

Refractive index

| | | |
|---|---|---|
| First and second anamorphic collimator | N1 | 1.5282 |
| lenses 102 and 202 | | |

Shape of optical element

| | | Main | Sub- |
|---|---|---|---|
| | | scanning | scanning |
| | | direction | direction |
| Curvature radius of incident surface | r1a | ∞ | ∞ |
| of first and second anamorphic | (mm) | | |
| collimator lenses 102 and 202 | | | |
| Curvature radius of exit surface | r1b | −37.169 | −26.170 |
| of first and second anamorphic | (mm) | | |
| collimator lenses 102 and 202 | | | |
| Phase coefficient of incident surface | D2, 0 | −7.847E−03 | — |
| of first and second anamorphic | D0, 2 | — | −8.669E−03 |
| collimator lenses 102 and 202 | | | |

Focal length

| | | Main | Sub- |
|---|---|---|---|
| | | scanning | scanning |
| | | direction | direction |
| First and second anamorphic collimator | fcol | 33.94 | 27.15 |
| lenses 102 and 202 | (mm) | | |

| Arrangement | | |
|---|---|---|
| First and second light sources 101 and 201 - | d0 | 33.59 |
| Incident surface of first and second | (mm) | |
| anamorphic collimator lenses 102 and 202 | | |
| Incident surface of first and second | d1 | 3.00 |
| anamorphic collimator lenses 102 and 202 - | (mm) | |
| Exit surface of first and second anamorphic | | |
| collimator lenses 102 and 202 | | |
| Exit surface of first and second anamorphic | d2 | 15.15 |
| collimator lenses 102 and 202 - | (mm) | |
| First and second sub-scanning stops 103 and 203 | | |
| First and second sub-scanning stops 103 and 203 - | d4 | 29.87 |
| First and second main scanning stops 104 and 204 | (mm) | |
| First and second main scanning stops 104 and 204 - | d5 | 80.09 |
| First deflecting surface of deflecting unit 1 | (mm) | |
| Incident angle in main scanning cross section of | A1 | 78.00 |
| light flux LA exiting from first main scanning | (deg) | |
| stop 104 to first deflecting surface | | |
| Incident angle in main scanning cross section | A2 | 78.00 |
| of light flux LB exiting from second main scanning | (deg) | |
| stop 204 to first deflecting surface | | |
| Incident angle in sub-scanning cross section of | A3 | 2.70 |
| light flux LA exiting from first main scanning | (deg) | |
| stop 104 to first deflecting surface | | |
| Incident angle in sub-scanning cross section of | A4 | −2.70 |
| light flux LB exiting from second main scanning | (deg) | |
| stop 204 to first deflecting surface | | |

TABLE 8
fθ coefficient, Scanning width, Maximum angle of view

| | | |
|---|---|---|
| fθ coefficient | k (mm/rad) | 207 |
| Scanning width | W (mm) | 330 |
| Maximum angle of view | θ(deg) | 45.7 |

| Refractive index | | |
|---|---|---|
| Refractive index of first fθ lens 106 | N5 | 1.52819 |
| Refractive index of second fθ lens 107 | N6 | 1.52819 |

Deflecting unit 1

| | | |
|---|---|---|
| Number of deflecting surfaces | | 4 |
| Circumscribed radius | Rpol (mm) | 10 |
| Rotation center - Deflection reference | Xpol (mm) | 6.03 |
| point C0 (Optical axis direction) | | |
| Rotation center - Deflection reference | Ypol (mm) | 3.79 |
| point C0 (main scanning direction) | | |

Arrangement in first scanning optical system 45b

| | | |
|---|---|---|
| Deflection reference point C0 - | d12 (mm) | 26.00 |
| Incident surface of first fθ lens 106 | | |
| Incident surface of first fθ lens 106 - | d13 (mm) | 8.20 |
| Exit surface of first fθ lens 106 | | |
| Exit surface of first fθ lens 106 - | d14 (mm) | 87.80 |
| Incident surface of second fθ lens 107 | | |
| Incident surface of second fθ lens 107 - | d15 (mm) | 4.30 |
| Exit surface of second fθ lens 107 | | |
| Exit surface of second fθ lens 107 - | d16 (mm) | 106.70 |
| First scanned surface 108 | | |
| Deflection reference point C0 - | L1(mm) | 26.00 |
| Incident surface of first fθ lens 106 | | |
| Deflection reference point C0 - | L2(mm) | 122.00 |
| Incident surface of second fθ lens 107 | | |
| Deflection reference point C0 - | T2(mm) | 233.00 |
| First scanned surface 108 | | |
| Sub-scanning eccentricity of | shiftZ(mm) | 7.21 |
| second fθ lens 107 | | |

| | |
|---|---|
| Meridional line shape of | Meridional line shape of |
| first fθ lens 106 | first fθ lens 107 |

| | Incident | Exit surface | | Incident | Exit surface |
|---|---|---|---|---|---|
| | surface | Opposite | | surface | Opposite |
| | Opposite light | light | | Opposite light | light |
| | source side | source side | | source side | source side |
| R | −71.101 | −43.800 | R | −4000 | 379.967 |
| ku | 9.464E−01 | −9.321E−01 | ku | 0 | −7.412E+01 |
| B4u | −9.147E−07 | 1.355E−06 | B4u | 0 | −1.332E−07 |
| B6u | 6.784E−09 | 1.719E−09 | B6u | 0 | 7.206E−12 |
| B8u | −5.767E−12 | 8.761E−13 | B8u | 0 | −3.070E−16 |
| B10u | 1.638E−15 | −1.069E−15 | B10u | 0 | 6.089E−21 |
| B12u | 0 | 0 | B12u | 0 | 0.000E+00 |
| | Light source | Light source | | Light source | Light source |
| | side | side | | side | side |
| k1 | 9.464E−01 | −9.321E−01 | k1 | 0 | −7.412E+01 |
| B41 | −9.147E−07 | −1.355E−06 | B41 | 0 | −1.332E−07 |
| B61 | 6.784E−09 | 1.719E−09 | B61 | 0 | 7.206E−12 |
| B81 | −5.767E−12 | 8.761E−13 | B81 | 0 | −3.070E−16 |
| B101 | 1.638E−15 | −1.069E−15 | B101 | 0 | 6.089E−21 |
| B121 | 0 | 0 | B121 | 0 | 0.000E+00 |

| Sagittal line shape of | | | Sagittal line shape of | | |
|---|---|---|---|---|---|
| first fθ lens 106 | | | second fθ lens 107 | | |
| | Incident | | | Incident | |
| | surface | Exit surface | | surface | Exit surface |
| | Sagittal line | Sagittal line | | Sagittal line | Sagittal line |
| | R change | R change | | R change | R change |
| r | 20.000 | 55.261 | r | 37.426 | −249.9931 |
| E1 | 0 | 0 | E1 | 0.000E+00 | 9.40981E−09 |
| E2 | 0 | 6.894E−06 | E2 | −3.482E−07 | 1.44641E−06 |
| E3 | 0 | 0 | E3 | 0 | −1.61579E−09 |
| E4 | 0 | 8.425E−08 | E4 | 0.000E+00 | −2.7926E−10 |
| E5 | 0 | 0 | E5 | 0 | 4.72069E−13 |
| E6 | 0 | −2.679E−10 | E6 | 0.000E+00 | 4.45476E−14 |
| E7 | 0 | 0 | E7 | 0 | −5.35403E−17 |
| E8 | 0 | 3.4364E−13 | E8 | 0.000E+00 | −3.93574E−18 |
| E9 | 0 | 0 | E9 | 0 | 2.02748E−21 |
| E10 | 0 | −1.53852E−16 | E10 | 0 | 1.36304E−22 |
| | Sagittal line | Sagittal line | | Sagittal line | Sagittal line |
| | tilt | tilt | | tilt | tilt |
| M0_1 | 0 | 7.661E−02 | M0_1 | 1.211E−01 | −5.801E−02 |
| M1_1 | 0 | 0.000E+00 | M1_1 | 2.129E−04 | 2.002E−04 |
| M2_1 | 0 | −3.906E−05 | M2_1 | 1.111E−05 | 2.292E−05 |
| M3_1 | 0 | 0.000E+00 | M3_1 | −1.419E−07 | −1.288E−07 |
| M4_1 | 0 | 0.000E+00 | M4_1 | −5.557E−10 | −2.627E−09 |
| M5_1 | 0 | 0 | M5_1 | 2.589E−11 | 2.174E−11 |
| M6_1 | 0 | 0 | M6_1 | −2.459E−13 | 2.067E−13 |
| M7_1 | 0 | 0 | M7_1 | −2.150E−15 | −1.675E−15 |
| M8_1 | 0 | 0 | M8_1 | 1.182E−17 | −3.209E−17 |
| M9_1 | 0 | 0 | M9_1 | 6.130E−20 | 4.199E−20 |
| M10_1 | 0 | 0 | M10_1 | 9.717E−23 | 1.487E−21 |
| M11_1 | 0 | 0 | M11_1 | 0 | 0 |
| M12_1 | 0 | 0 | M12_1 | 0 | 0 |

TABLE 9
fθ coefficient, Scanning width, Maximum angle of view

| | | |
|---|---|---|
| fθ coefficient | k (mm/rad) | 207 |
| Scanning width | W (mm) | 330 |
| Maximum angle of view | θ(deg) | 45.7 |

Refractive index

| | | |
|---|---|---|
| Refractive index of first fθ lens 206 | N5 | 1.52819 |
| Refractive index of second fθ lens 207 | N6 | 1.52819 |

Deflecting unit 1

| | | |
|---|---|---|
| Number of deflecting surfaces | | 4 |
| Circumscribed radius | Rpol (mm) | 10 |
| Rotation center - Deflection reference | Xpol (mm) | 6.03 |
| point C0 (Optical axis direction) | | |
| Rotation center - Deflection reference | Ypol (mm) | 3.79 |
| point C0 (main scanning direction) | | |

Arrangement in second scanning optical system 55b

| | | |
|---|---|---|
| Deflection reference point C0 - | d12 (mm) | 26.00 |
| Incident surface of first fθ lens 206 | | |
| Incident surface of first fθ lens 206 - | d13 (mm) | 8.20 |
| Exit surface of first fθ lens 206 | | |
| Exit surface of first fθ lens 206 - | d14 (mm) | 69.30 |
| Incident surface of second fθ lens 207 | | |
| Incident surface of second fθ lens 207 - | d15 (mm) | 4.30 |
| Exit surface of second fθ lens 207 | | |
| Exit surface of second fθ lens 207 - | d16 (mm) | 125.20 |
| Second scanned surface 208 | | |
| Deflection reference point C0 - | L3(mm) | 26.00 |
| Incident surface of first fθ lens 206 | | |
| Deflection reference point C0 - | L4(mm) | 103.50 |
| Incident surface of second fθ lens 207 | | |
| Deflection reference point C0 - | T2(mm) | 233.00 |
| Second scanned surface 208 | | |
| Sub-scanning eccentricity of second fθ | shiftZ(mm) | 5.03 |
| lens 207 | | |

| Meridional line shape of | | | Meridional line shape of | | |
|---|---|---|---|---|---|
| second fθ lens 206 | | | second fθ lens 207 | | |
| | Incident | Exit surface | | Incident | Exit surface |
| | surface | Opposite | | surface | Opposite |
| | Opposite light | light | | Opposite light | light |
| | source side | source side | | source side | source side |
| R | −71.101 | −42.946 | R | −4000 | 350.123 |
| ku | 9.464E−01 | −5.155E−01 | ku | 0 | −8.753E+01 |
| B4u | −9.147E−07 | −3.477E−07 | B4u | 0 | −2.020E−07 |
| B6u | 6.784E−09 | 1.690E−09 | B6u | 0 | 1.609E−11 |
| B8u | −5.767E−12 | 1.110E−12 | B8u | 0 | −9.313E−16 |
| B10u | 1.638E−15 | −1.224E−15 | B10u | 0 | 2.524E−20 |
| B12u | 0 | 0 | B12u | 0 | 0 |
| | Light source | Light source | | Light source | Light source |
| | side | side | | side | side |
| k1 | 9.464E−01 | −5.155E−01 | k1 | 0 | −8.753E+01 |
| B41 | −9.147E−07 | −3.477E−07 | B41 | 0 | −2.020E−07 |
| B61 | 6.784E−09 | 1.690E−09 | B61 | 0 | 1.609E−11 |
| B81 | −5.767E−12 | 1.110E−12 | B81 | 0 | −9.313E−16 |
| B101 | 1.638E−15 | −1.224E−15 | B101 | 0 | 2.524E−20 |
| B121 | 0 | 0 | B121 | 0 | 0 |

| Sagittal line shape of | | | Sagittal line shape of | | |
|---|---|---|---|---|---|
| first fθ lens 206 | | | second fθ lens 207 | | |
| | Incident | | | Incident | |
| | surface | Exit surface | | surface | Exit surface |
| | Sagittal line | Sagittal line | | Sagittal line | Sagittal line |
| | R change | R change | | R change | R change |
| r | 20.000 | 25.004 | r | 37.079 | −154.0078 |
| E1 | 0 | 0 | E1 | 0 | −1.27778E−07 |
| E2 | 0 | 1.522E−05 | E2 | −7.458E−07 | 1.81313E−06 |
| E3 | 0 | 0 | E3 | 0 | −3.2397E−09 |
| E4 | 0 | 8.486E−10 | E4 | 0 | −3.04103E−10 |
| E5 | 0 | 0 | E5 | 0 | 1.33875E−12 |
| E6 | 0 | −2.508E−11 | E6 | 0 | 3.08183E−14 |
| E7 | 0 | 0 | E7 | 0 | −2.00884E−16 |
| E8 | 0 | 7.60678E−15 | E8 | 0 | −1.95419E−18 |
| E9 | 0 | 0 | E9 | 0 | 9.85865E−21 |
| E10 | 0 | 1.60971E−17 | E10 | 0 | 5.81192E−23 |
| | Sagittal line | Sagittal line | | Sagittal line | Sagittal line |
| | tilt | tilt | | tilt | tilt |
| M0_1 | 0 | 2.124E−02 | M0_1 | −1.007E−01 | 2.315E−02 |
| M1_1 | 0 | 0 | M1_1 | −2.129E−04 | −2.002E−04 |
| M2_1 | 0 | −3.321E−05 | M2_1 | −1.314E−05 | −2.370E−05 |
| M3_1 | 0 | 0 | M3_1 | 1.161E−07 | 1.056E−07 |
| M4_1 | 0 | 0 | M4_1 | 1.765E−09 | 3.675E−09 |
| M5_1 | 0 | 0 | M5_1 | −1.616E−11 | −1.409E−11 |
| M6_1 | 0 | 0 | M6_1 | 3.014E−13 | −3.052E−13 |
| M7_1 | 0 | 0 | M7_1 | 1.061E−15 | 9.733E−16 |
| M8_1 | 0 | 0 | M8_1 | −1.306E−17 | 6.574E−17 |
| M9_1 | 0 | 0 | M9_1 | −1.657E−20 | −1.728E−20 |
| M10_1 | 0 | 0 | M10_1 | −8.536E−22 | −3.960E−21 |
| M11_1 | 0 | 0 | M11_1 | 0 | 0 |
| M12_1 | 0 | 0 | M12_1 | 0 | 0 |

In Tables 7 to 9, an optical axis, an axis orthogonal to the optical axis in the main scanning cross section, and an axis orthogonal to the optical axis in the sub-scanning cross section are defined as an X-axis, a Y-axis, and a Z-axis, respectively, when an intersection between each lens surface and the optical axis is defined as an origin.

Further, in Tables 8 and 9, “E-x” means “×10^{-x}”.

An aspheric surface shape (meridional line shape) in the main scanning cross section of each lens surface of the first fθ lenses 106 and 206 and the second fθ lenses 107 and 207 provided in the light scanning apparatus 710 according to the aspect of the embodiment is expressed by the above-described Expression (1).

An aspheric surface shape (sagittal line shape) in the sub-scanning cross section of each lens surface of the first fθ lenses 106 and 206 and the second fθ lenses 107 and 207 provided in the light scanning apparatus 710 according to the aspect of the embodiment is expressed by the above-described Expression (2).

A curvature radius r′ in the sub-scanning cross section of each lens surface of the first fθ lenses 106 and 206 and the second fθ lenses 107 and 207 provided in the light scanning apparatus 710 according to the aspect of the embodiment continuously varies in accordance with a position in the Y direction as expressed by the above-described Expression (3).

Each of the first and second anamorphic collimator lenses 102 and 202 provided in the light scanning apparatus 710 according to the aspect of the embodiment has an incident surface formed by a diffracting surface defined by an optical path difference function of two variables Y and Z as expressed by the above-described Expression (4).

Further, Inequality (11) be satisfied in the first incident optical system 45a and the first scanning optical system 45b provided in the light scanning apparatus 710 according to the aspect of the embodiment.

In other words, an inclination at the arrival position of the light beam from the i-th light emitting point of the first light source 101 on the exit surface (first sagittal line tilt surface, first optical surface) of the first fθ lens 106 provided in the light scanning apparatus 710 according to the aspect of the embodiment is represented by M₁ᵢ. A lateral magnification in the sub-scanning cross section of the first incident optical system 45a is represented by β₁.

A distance on the optical axis of the first incident optical system 45a between the first light source 101 and the first deflecting surface of the deflecting unit 1 provided in the light scanning apparatus 710 according to the aspect of the embodiment is represented by L₁ (mm).

A distance on the optical axis of the first scanning optical system 45b between the first deflecting surface of the deflecting unit 1 and the exit surface of the first fθ lens 106 provided in the light scanning apparatus 710 according to the aspect of the embodiment is represented by D₁ (mm).

At this time, in the first incident optical system 45a and the first scanning optical system 45b provided in the light scanning apparatus 710 according to the aspect of the embodiment, the following Inequality (11c) be satisfied:

$$0.05 < \vert {M}_{1 i} [ - {β}_{1} + \frac{( 1 - {β}_{1} ) {D}_{1}}{{L}_{1}} ] \vert < 0.7 . \qquad ( 11 c )$$

In the first incident optical system 45a and the first scanning optical system 45b provided in the light scanning apparatus 710 according to the aspect of the embodiment, Inequality (11a) be satisfied, and it is more preferred that Inequality (11b) be satisfied.

Further, in the first incident optical system 45a and the first scanning optical system 45b provided in the light scanning apparatus 710 according to the aspect of the embodiment, Inequalities (12) and (13) be satisfied.

In other words, the following Inequality (12a) be satisfied by using the aspheric surface coefficient M₀₁ of the exit surface of the first fθ lens 106 provided in the light scanning apparatus 710 according to the aspect of the embodiment:

$$0 < \vert {M}_{01} [ - {β}_{1} + \frac{( 1 - {β}_{1} ) {D}_{1}}{{L}_{1}} ] \vert < 0.185 . \qquad ( 12 a )$$

Further, in other words, a curvature radius in the sub-scanning cross section of the exit surface of the first fθ lens 106 on the optical axis of the first scanning optical system 45b is represented by R (mm), and an eccentricity amount in the sub-scanning direction of the first fθ lens 106 is represented by Lₛ (mm).

At this time, the following Inequality (13a) be satisfied:

$$0.05 < \vert [ \frac{{L}_{s}}{R} + {M}_{01} ] \times [ - {β}_{1} + \frac{( 1 - {β}_{1} ) {D}_{1}}{{L}_{1}} ] \vert < 0.7 . \qquad ( 13 a )$$

Specifically, in the first incident optical system 45a and the first scanning optical system 45b provided in the light scanning apparatus 710 according to the aspect of the embodiment, β is −3.65, D is 34.2 mm, Lis 161.7 mm, and M is 0.100.

Therefore, the value of each of Inequalities (11), (11a) and (11b) is calculated as 0.465, so that Inequalities (11), (11a) and (11b) are satisfied.

On the other hand, in the first incident optical system 45a and the first scanning optical system 45b provided in the light scanning apparatus 710 according to the aspect of the embodiment, since M₀₁ is 0.0766, the value of Inequality (12) is calculated as 0.355, so that Inequality (12) is not satisfied.

Further, in the first incident optical system 45a and the first scanning optical system 45b provided in the light scanning apparatus 710 according to the aspect of the embodiment, Lₛ is 1.31 mm and R is 55.261 mm. Therefore, the value of Inequality (13) is calculated as 0.465, so that Inequality (13) is satisfied.

In addition, in the second incident optical system 55a and the second scanning optical system 55b provided in the light scanning apparatus 710 according to the aspect of the embodiment, Inequality (11) be satisfied.

In other words, an inclination at the arrival position of the light beam from the j-th light emitting point of the second light source 201 on the exit surface (second sagittal line tilt surface, second optical surface) of the first fθ lens 206 provided in the light scanning apparatus 710 according to the aspect of the embodiment is represented by M₂ⱼ.

A lateral magnification in the sub-scanning cross section of the second incident optical system 55a is represented by β₂.

A distance on the optical axis of the second incident optical system 55a between the second light source 201 and the first deflecting surface of the deflecting unit 1 provided in the light scanning apparatus 710 according to the aspect of the embodiment is represented by L₂ (mm).

A distance on the optical axis of the second scanning optical system 55b between the first deflecting surface of the deflecting unit 1 and the exit surface of the first fθ lens 206 provided in the light scanning apparatus 710 according to the aspect of the embodiment is represented by D₂ (mm).

At this time, in the second incident optical system 55a and the second scanning optical system 55b provided in the light scanning apparatus 710 according to the aspect of the embodiment, the following Inequality (11d) be satisfied:

$$0.05 < \vert {M}_{2 j} [ - {β}_{2} + \frac{( 1 - {β}_{2} ) {D}_{2}}{{L}_{2}} ] \vert < 0.7 . \qquad ( 11 d )$$

Further, in the second incident optical system 55a and the second scanning optical system 55b provided in the light scanning apparatus 710 according to the aspect of the embodiment, Inequality (11a) be satisfied, and it is more preferred that Inequality (11b) be satisfied.

In addition, in the second incident optical system 55a and the second scanning optical system 55b provided in the light scanning apparatus 710 according to the aspect of the embodiment, Inequalities (12) and (13) be satisfied.

Specifically, in the second incident optical system 55a and the second scanning optical system 55b provided in the light scanning apparatus 710 according to the aspect of the embodiment, β is −3.65, D is 34.2 mm, Lis 161.7 mm, and M is 0.0735.

Therefore, the value of each of Inequalities (11), (11a) and (11b) is calculated as 0.341, so that Inequalities (11), (11a) and (11b) are satisfied.

Further, in the second incident optical system 55a and the second scanning optical system 55b provided in the light scanning apparatus 710 according to the aspect of the embodiment, since M₀₁ is 0.0212, the value of Inequality (12) is calculated as 0.098, so that Inequality (12) is satisfied.

Furthermore, in the second incident optical system 55a and the second scanning optical system 55b provided in the light scanning apparatus 710 according to the aspect of the embodiment, since Lₛ is 1.31 mm and R is 25.004 mm, the value of Inequality (13) is calculated as 0.341, so that Inequality (13) is satisfied.

Note that, in the light scanning apparatus 710 according to the aspect of the embodiment, an absolute value of the sagittal line tilt amount M₀₁ on the optical axis of the exit surface of the first fθ lens 106 and an absolute value of the sagittal line tilt amount M₀₁ on the optical axis of the exit surface of the first fθ lens 206 are different from each other.

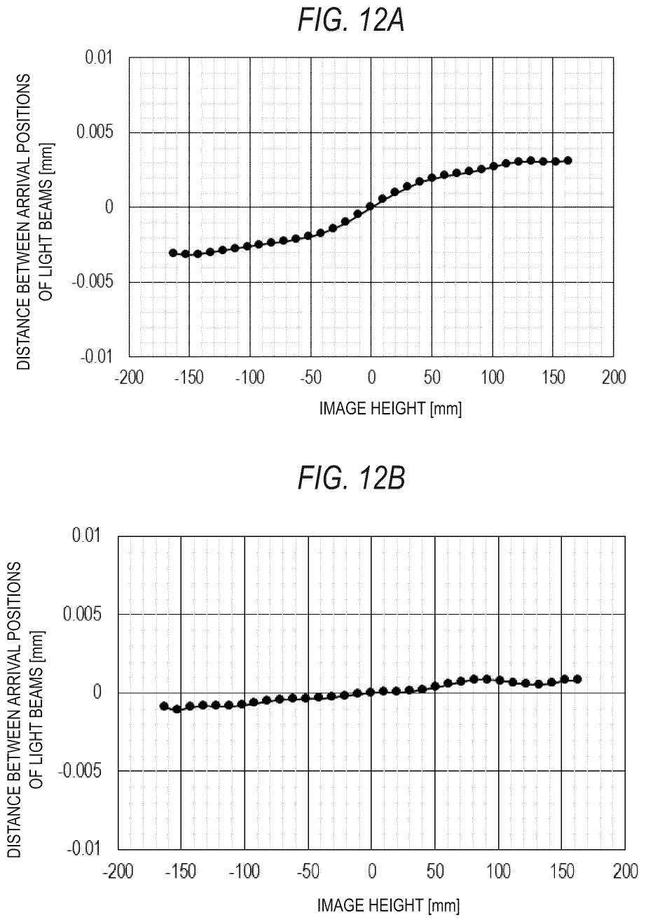

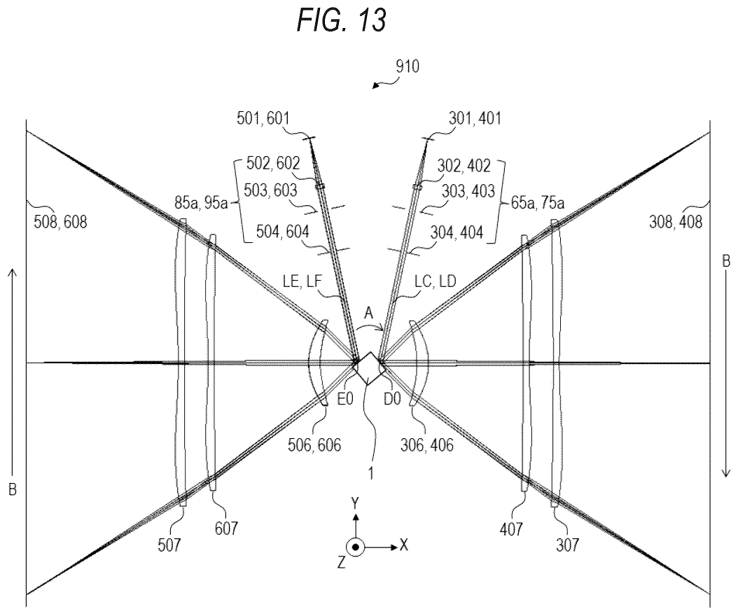

FIG. 12A shows distances in the main scanning direction between the arrival position of the light beam 2105a and the arrival position of the light beam 2105b at the respective image heights on the first scanned surface 108 in the light scanning apparatus 710 according to the aspect of the embodiment.

That is, the distances include d4, d5, and do shown in FIG. 3B, and the distance at the on-axis image height is shown as 0 mm in FIG. 12A.

FIG. 12B shows distances in the main scanning direction between the arrival position of the light beam 2105a and the arrival position of the light beam 2105b at the respective image heights on the second scanned surface 208 in the light scanning apparatus 710 according to the aspect of the embodiment.

That is, the distances include d4, d5, and d6 shown in FIG. 3B, and the distance at the on-axis image height is shown as 0 mm in FIG. 12B.

As shown in FIG. 12A, in the light scanning apparatus 710 according to the aspect of the embodiment, a difference between a maximum value and a minimum value of the distances on the first scanned surface 108 is 6.3 μm.

Since the difference corresponds to a deviation of about 7.4% with respect to 300 dpi, namely a pitch of 84.7 μm, an influence of the deviation of the arrival position of each light beam on the first scanned surface 108 on the image quality can be reduced.

Further, as shown in FIG. 12B, in the light scanning apparatus 710 according to the aspect of the embodiment, a difference between a maximum value and a minimum value of the distances on the second scanned surface 208 is 2.0 μm.

Since the difference corresponds to a deviation of about 2.3% with respect to 300 dpi, namely the pitch of 84.7 μm, an influence of the deviation of the arrival position of each light beam on the second scanned surface 208 on the image quality can be reduced.

As described above, in the light scanning apparatus 710 according to the aspect of the embodiment, Inequalities (11) and (13) are satisfied for the first incident optical system 45a and the first scanning optical system 45b.

On the other hand, all of Inequalities (11), (12) and (13) are satisfied for the second incident optical system 55a and the second scanning optical system 55b.

This makes it possible to reduce the distances in the main scanning direction between the arrival position of the light beam 2105a and the arrival position of the light beam 2105b at the respective image heights on the second scanned surface 208 than on the first scanned surface 108.

As described above, in the light scanning apparatus 710 according to the aspect of the embodiment, Inequality (11) is satisfied in the first incident optical system 45a and the first scanning optical system 45b, thereby it is possible to suppress a deterioration of the image quality due to the deviation of the arrival position of each light beam on the first scanned surface 108.

Further, in the light scanning apparatus 710 according to the aspect of the embodiment, Inequality (11) is satisfied in the second incident optical system 55a and the second scanning optical system 55b, thereby it is possible to suppress a deterioration of the image quality due to the deviation of the arrival position of each light beam on the second scanned surface 208.

### Fifth Embodiment

FIG. 13 shows a schematic developed view in the main scanning cross section of a light scanning apparatus 910 according to a fifth embodiment of the disclosure.

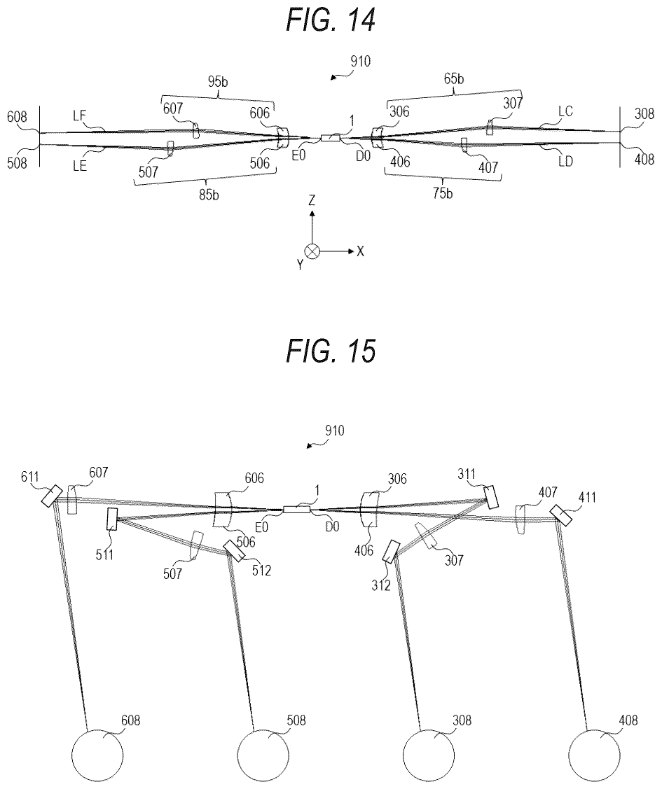

FIGS. 14 and 15 show a schematic partial developed view in the sub-scanning cross section and a schematic partial sub-scanning cross sectional view of the light scanning apparatus 910 according to the fifth embodiment, respectively.

The light scanning apparatus 910 according to the aspect of the embodiment includes first, second, third and fourth light sources 301, 401, 501 and 601, and first, second, third and fourth anamorphic collimator lenses 302, 402, 502 and 602.

Further, the light scanning apparatus 910 according to the aspect of the embodiment includes first, second, third and fourth sub-scanning stops 303, 403, 503, and 603, and first, second, third and fourth main scanning stops 304, 404, 504 and 604.

Furthermore, the light scanning apparatus 910 according to the aspect of the embodiment includes a deflecting unit 1, first fθ lenses 306, 406, 506 and 606, second fθ lenses 307, 407, 507 and 607, and folding mirrors 311, 312, 411, 511, 512 and 611.

On optical paths, the first fθ lens 306 is arranged between the deflecting unit 1 and the second fθ lens 307, and the first fθ lens 406 is arranged between the deflecting unit 1 and the second fθ lens 407.

On optical paths, the first fθ lens 506 is arranged between the deflecting unit 1 and the second fθ lens 507, and the first fθ lens 606 is arranged between the deflecting unit 1 and the second fθ lens 607.

As each of the first, second, third and fourth light sources 301, 401, 501 and 601, a semiconductor laser or the like having a plurality of light emitting points is used.

The first, second, third and fourth anamorphic collimator lenses 302, 402, 502 and 602 convert the light fluxes LC, LD, LE and LF emitted from the first, second, third and fourth light sources 301, 401, 501 and 601 into parallel light fluxes in the main scanning cross section, respectively, and condense the light fluxes LC, LD, LE and LF in the sub-scanning cross section, respectively.

The parallel light flux includes not only a strictly parallel light flux but also a substantially parallel light flux such as a weakly divergent light flux or a weakly convergent light flux.

The first, second, third and fourth sub-scanning stops 303, 403, 503 and 603 limit light flux diameters in the sub-scanning direction of the light fluxes LC, LD, LE and LF that have passed through the first, second, third and fourth anamorphic collimator lenses 302, 402, 502 and 602, respectively.

The first, second, third and fourth main scanning stops 304, 404, 504 and 604 limit light flux diameters in the main scanning direction of the light fluxes LC, LD, LE, and LF that have passed through the first, second, third and fourth sub-scanning stops 303, 403, 503 and 603, respectively.

In this way, the light fluxes LC and LD emitted from the first and second light sources 301 and 401 are condensed in the sub-scanning direction in the vicinity of a first deflecting surface of the deflecting unit 1, respectively, so that line images elongated in the main scanning direction are formed.

Further, the light fluxes LE and LF emitted from the third and fourth light sources 501 and 601 are condensed in the sub-scanning direction in the vicinity of a second deflecting surface of the deflecting unit 1, respectively, so that line images elongated in the main scanning direction are formed.

The deflecting unit 1 deflects the incident light fluxes LC, LD, LE and LF with rotating in a direction indicated by an arrow A in FIG. 13 by a driving unit such as a motor (not shown). The deflecting unit 1 is formed by a polygon mirror, for example.

The first fθ lens 306 (first optical element, first imaging optical element) and the second fθ lens 307 are anamorphic imaging lenses having different powers between the main scanning cross section and the sub-scanning cross section, and condense (guide) the light flux LC deflected by the first deflecting surface of the deflecting unit 1 onto the first scanned surface 308.

The first fθ lens 406 (second optical element, second imaging optical element) and the second fθ lens 407 are anamorphic imaging lenses having different powers between the main scanning cross section and the sub-scanning cross section, and condense (guide) the light flux LD deflected by the first deflecting surface of the deflecting unit 1 onto the second scanned surface 408.

The first fθ lens 506 (third optical element, third imaging optical element) and the second fθ lens 507 are anamorphic imaging lenses having different powers between the main scanning cross section and the sub-scanning cross section, and condense (guide) the light flux LE deflected by the second deflecting surface of the deflecting unit 1 onto the third scanned surface 508.

The first fθ lens 606 (fourth optical element, fourth imaging optical element) and the second fθ lens 607 are anamorphic imaging lenses having different powers between the main scanning cross section and the sub-scanning cross section, and condense (guide) the light flux LF deflected by the second deflecting surface of the deflecting unit 1 on the fourth scanned surface 608.

The folding mirrors 311 and 312 reflect the light flux LC deflected by the first deflecting surface of the deflecting unit 1 so as to fold the optical path of the light flux LC, and the folding mirror 411 reflects the light flux LD deflected by the first deflecting surface of the deflecting unit 1 so as to fold the optical path of the light flux LD.

The folding mirrors 511 and 512 reflect the light flux LE deflected by the second deflecting surface of the deflecting unit 1 so as to fold the optical path of the light flux LE, and the folding mirror 611 reflects the light flux LF deflected by the second deflecting surface of the deflecting unit 1 so as to fold the optical path of the light flux LF.

In the light scanning apparatus 910 according to the aspect of the embodiment, a first incident optical system 65a is formed by the first anamorphic collimator lens 302, the first sub-scanning stop 303 and the first main scanning stop 304.

A second incident optical system 75a is formed by the second anamorphic collimator lens 402, the second sub-scanning stop 403 and the second main scanning stop 404.

A third incident optical system 85a is formed by the third anamorphic collimator lens 502, the third sub-scanning stop 503 and the third main scanning stop 504.

A fourth incident optical system 95a is formed by the fourth anamorphic collimator lens 602, the fourth sub-scanning stop 603 and the fourth main scanning stop 604.

Further, in the light scanning apparatus 910 according to the aspect of the embodiment, a first scanning optical system 65b is formed by the first fθ lens 306 and the second fθ lens 307, and a second scanning optical system 75b is formed by the first fθ lens 406 and the second fθ lens 407.

A third scanning optical system 85b is formed by the first fθ lens 506 and the second fθ lens 507, and a fourth scanning optical system 95b is formed by the first fθ lens 606 and the second fθ lens 607.

A refractive power in the sub-scanning cross section of the second fθ lenses 307, 407, 507 and 607 is stronger than a refractive power in the sub-scanning cross section of the first fθ lenses 306, 406, 506 and 606, namely the strongest in the first, second, third and fourth scanning optical systems 65b, 75b, 85b and 95b, respectively.

The light fluxes LC emitted from the respective light emitting points of the first light source 301 pass through the first incident optical system 65a to be incident on the first deflecting surface of the deflecting unit 1.

Then, the light fluxes LC incident on the first deflecting surface of the deflecting unit 1 from the first light source 301 are deflected by the first deflecting surface of the deflecting unit 1 to be guided onto the first scanned surface 308 by the first scanning optical system 65b, thereby the first scanned surface 308 is scanned at a constant speed.

The light fluxes LD emitted from the respective light emitting points of the second light source 401 pass through the second incident optical system 75a to be incident on the first deflecting surface of the deflecting unit 1.

Then, the light fluxes LD incident on the first deflecting surface of the deflecting unit 1 from the second light source 401 are deflected by the first deflecting surface of the deflecting unit 1 to be guided onto the second scanned surface 408 by the second scanning optical system 75b, thereby the second scanned surface 408 is scanned at a constant speed.

The light fluxes LE emitted from the respective light emitting points of the third light source 501 pass through the third incident optical system 85a to be incident on the second deflecting surface of the deflecting unit 1.

Then, the light fluxes LE incident on the second deflecting surface of the deflecting unit 1 from the third light source 501 are deflected by the second deflecting surface of the deflecting unit 1 to be guided onto the third scanned surface 508 by the third scanning optical system 85b, thereby the third scanned surface 508 is scanned at a constant speed.

The light fluxes LF emitted from the respective light emitting points of the fourth light source 601 pass through the fourth incident optical system 95a to be incident on the second deflecting surface of the deflecting unit 1.

Then, the light fluxes LF incident on the second deflecting surface of the deflecting unit 1 from the fourth light source 601 are deflected by the second deflecting surface of the deflecting unit 1 to be guided onto the fourth scanned surface 608 by the fourth scanning optical system 95b, thereby the fourth scanned surface 608 is scanned at a constant speed.

Since the deflecting unit 1 rotates in the direction indicated by the arrow A in FIG. 13, the light fluxes LC, LD, LE and LF deflected by the deflecting unit 1 scan the first, second, third and fourth scanned surfaces 308, 408, 508 and 608 in a direction indicated by an arrow B in FIG. 13, respectively.

In FIGS. 13 to 15, D0 and E0 represent deflection points (on-axis deflection points) on the first and second deflecting surfaces of the deflecting unit 1 with respect to a principal ray of an on-axis light flux, respectively.

The deflection point D0 serves as a reference point of the first and second scanning optical systems 65b and 75b, and the deflection point E0 serves as a reference point of the third and fourth scanning optical systems 85b and 95b.

In the aspect of the embodiment, first, second, third and fourth photosensitive drums 308, 408, 508 and 608 are used as the first, second, third and fourth scanned surfaces 308, 408, 508 and 608.

Exposure distributions in the sub-scanning direction on the first, second, third and fourth photosensitive drums 308, 408, 508, and 608 are formed by rotating the first, second, third and fourth photosensitive drums 308, 408, 508 and 608 in the sub-scanning direction for each main scanning exposure, respectively.

Next, various characteristics of the first, second, the third and fourth incident optical systems 65a, 75a, 85a and 95a, and first, second, third and fourth scanning optical systems 65b, 75b, 85b and 95b provided in the light scanning apparatus 910 according to the aspect of the embodiment are shown in the following Tables 10 to 12.

TABLE 10
Characteristics of first, second, third and fourth
light sources 301, 401, 501 and 601

| | | |
|---|---|---|
| Wavelength | λ(nm) | 790 |
| Incident polarization to first and second | | p |
| deflecting surfaces of deflecting unit 1 | | polarization |
| Full angle at half maximum in main scanning | FFPy(deg) | 12.00 |
| direction | | |
| Full angle at half maximum in sub-scanning | FFPz(deg) | 30.00 |
| direction | | |

Shape of stop

| | Main | Sub- |
|---|---|---|
| | scanning | scanning |
| | direction | direction |
| First, second, third and fourth sub- | 10.000 | 2.840 |
| scanning stops 303, 403, 503 and 603 | | |
| First, second, third and fourth main | 3.750 | — |
| scanning stops 304, 404, 504 and 604 | | |

Refractive index

| | | |
|---|---|---|
| First, second, third and fourth anamorphic | N1 | 1.5282 |
| collimator lenses 302, 402, 502 and 602 | | |

Shape of optical element

| | | Main | Sub- |
|---|---|---|---|
| | | scanning | scanning |
| | | direction | direction |
| Curvature radius of incident surface | r1a | ∞ | ∞ |
| of first, second, third and fourth | (mm) | | |
| anamorphic collimator lenses 302, | | | |
| 402, 502 and 602 | | | |
| Curvature radius of exit surface of | r1b | −37.169 | −26.170 |
| first, second, third and fourth | (mm) | | |
| anamorphic collimator lenses 302, | | | |
| 402, 502 and 602 | | | |
| Phase coefficient of incident surface | D2, 0 | −7.847E−03 | — |
| of first, second, third and fourth | D0, 2 | — | −8.669E−03 |
| anamorphic collimator lenses 302, | | | |
| 402, 502 and 602 | | | |

Focal length

| | | Main | Sub- |
|---|---|---|---|
| | | scanning | scanning |
| | | direction | direction |
| First to fourth anamorphic | fcol (mm) | 33.94 | 27.15 |
| collimator lenses 302 to 602 | | | |

Arrangement

| | | |
|---|---|---|
| First to fourth light sources 301 to 601 - | d0 | 33.59 |
| Incident surface of first to fourth anamorphic | (mm) | |
| collimator lenses 302 to 602 | | |
| Incident surface of first to fourth anamorphic | d1 | 3.00 |
| collimator lenses 302 to 602 - | (mm) | |
| Exit surface of first to fourth anamorphic | | |
| collimator lenses 302 to 602 | | |
| Exit surface of first to fourth anamorphic | d2 | 15.15 |
| collimator lenses 302 to 602 - | (mm) | |
| First to fourth sub-scanning stops 303 to 603 | | |
| First to fourth sub-scanning stops 303 to 603 - | d4 | 29.87 |
| First to fourth main scanning stop 304 to 604 | (mm) | |
| First to fourth main scanning stop 304 to 604 - | d5 | 80.09 |
| First and second deflecting surfaces of | (mm) | |
| deflecting unit 1 | | |
| Incident angle in main scanning cross section | A1 | 78.00 |
| of light flux LC exiting from first main scanning | (deg) | |
| stop 304 to first deflecting surface | | |
| Incident angle in main scanning cross section | A2 | 78.00 |
| of light flux LD exiting from second main scanning | (deg) | |
| stop 404 to first deflecting surface | | |
| Incident angle in main scanning cross section | A3 | 102.00 |
| of light flux LE exiting from third main scanning | (deg) | |
| stop 504 to second deflecting surface | | |
| Incident angle in main scanning cross section | A4 | 102.00 |
| of light flux LF exiting from fourth main scanning | (deg) | |
| stop 604 to second deflecting surface | | |
| Incident angle in sub-scanning cross section | A5 | 2.70 |
| of light flux LC exiting from first main scanning | (deg) | |
| stop 304 to first deflecting surface | | |
| Incident angle in sub-scanning cross section | A6 | −2.70 |
| of light flux LD exiting from second main scanning | (deg) | |
| stop 404 to first deflecting surface | | |
| Incident angle in sub-scanning cross section | A7 | −2.70 |
| of light flux LE exiting from third main scanning | (deg) | |
| stop 504 to second deflecting surface | | |
| Incident angle in sub-scanning cross section | A8 | 2.70 |
| of light flux LF exiting from fourth main scanning | (deg) | |
| stop 604 to second deflecting surface | | |

TABLE 11
fθ coefficient, Scanning width, Maximum angle of view

| | | |
|---|---|---|
| fθ coefficient | k (mm/rad) | 207 |
| Scanning width | W (mm) | 330 |
| Maximum angle of view | θ(deg) | 45.7 |

Refractive index

| | | |
|---|---|---|
| Refractive index of first fθ lenses 306 and 506 | N5 | 1.52819 |
| Refractive index of second fθ lenses 307 and 507 | N6 | 1.52819 |

Deflecting unit 1

| | | |
|---|---|---|
| Number of deflecting surfaces | | 4 |
| Circumscribed radius | Rpol (mm) | 10 |
| Rotation center - Deflection reference points | Xpol (mm) | 6.03 |
| D0 and E0 (Optical axis direction) | | |
| Rotation center - Deflection reference points | Ypol (mm) | 3.79 |
| D0 and E0 (main scanning direction) | | |

Arrangement in first and third scanning
optical systems 65b and 85b

| | | |
|---|---|---|
| Deflection reference points D0 and E0 - | d12 (mm) | 26.00 |
| Incident surface of first fθ lenses 306 and 506 | | |
| Incident surface of first fθ lenses 306 and 506 - | d13 (mm) | 8.20 |
| Exit surface of first fθ lenses 306 and 506 | | |
| Exit surface of first fθ lenses 306 and 506 - | d14 (mm) | 87.80 |
| Incident surface of second fθ lenses 307 and 507 | | |
| Incident surface of second fθ lenses 307 and 507 - | d15 (mm) | 4.30 |
| Exit surface of second fθ lenses 307 and 507 | | |
| Exit surface of second fθ lenses 307 and 507 - | d16 (mm) | 106.70 |
| First and third scanned surfaces 308 and 508 | | |
| Deflection reference points D0 and E0 - | L1 (mm) | 26.00 |
| Incident surface of first fθ lenses 306 and 506 | | |
| Deflection reference points D0 and E0 - | L2 (mm) | 122.00 |
| Incident surface of second ff lenses 307 and 507 | | |
| Deflection reference points D0 and E0 - | T2 (mm) | 233.00 |
| First and third scanned surfaces 308 and 508 | | |
| Sub-scanning eccentricity of second fθ lenses | shiftZ | 9.06 |
| 307 and 507 | (mm) | |

| Meridional line shape of | | | Meridional line shape of | | |
|---|---|---|---|---|---|
| first fθ lenses 306 and 506 | | | second fθ lenses 307 and 507 | | |
| | Incident | Exit surface | | Incident | Exit surface |
| | surface | Opposite | | surface | Opposite |
| | Opposite light | light | | Opposite light | light |
| | source side | source side | | source side | source side |
| R | −71.974 | −44.323 | R | −4000 | 383.925 |
| Ku | 8.921E−01 | −1.162E+00 | ku | 0 | −7.626E+01 |
| B4u | −7.612E−07 | −1.519E−06 | B4U | 0 | −1.344E−07 |
| B6u | 6.789E−09 | 1.750E−09 | B6u | 0 | 7.455E−12 |
| B8u | −5.889E−12 | 9.640E−13 | B8u | 0 | −3.304E−16 |
| B10u | 1.617E−15 | −1.195E−15 | B10u | 0 | 7.016E−21 |
| B12u | 0 | 0 | B12u | 0 | 0.000E+00 |
| | Light source | Light source | | Light source | Light source |
| | side | side | | side | side |
| k1 | 8.921E−01 | −1.162E+00 | k1 | 0 | −7.626E+01 |
| B41 | −7.612E−07 | −1.519E−06 | B41 | 0 | −1.344E−07 |
| B61 | 6.789E−09 | 1.750E−09 | B61 | 0 | 7.455E−12 |
| B81 | −5.889E−12 | 9.640E−13 | B81 | 0 | −3.304E−16 |
| B101 | 1.617E−15 | −1.195E−15 | B101 | 0 | 7.016E−21 |
| B121 | 0 | 0 | B121 | 0 | 0.000E+00 |

| Sagittal line shape of | | | Sagittal line shape of | | |
|---|---|---|---|---|---|
| first fθ lenses 306 and 506 | | | first fθ lenses 307 and 507 | | |
| | Incident | | | Incident | |
| | surface | Exit surface | | surface | Exit surface |
| | Sagittal line | Sagittal line | | Sagittal line | Sagittal line |
| | R change | R change | | R change | R change |
| r | 20.000 | 54.586 | r | 46.180 | −110.3864 |
| E1 | 0 | 0 | E1 | 0 | −7.53378E−07 |
| E2 | 0 | 3.970E−06 | E2 | 5.267E−09 | 1.78758E−06 |
| E3 | 0 | 0 | E3 | 0 | −7.47644E−10 |
| E4 | 0 | 9.864E−08 | E4 | 0 | −2.81187E−10 |
| E5 | 0 | 0 | E5 | 0 | 1.8249E−13 |
| E6 | 0 | −2.887E−10 | E6 | 0 | 4.07154E−14 |
| E7 | 0 | 0 | E7 | 0 | −1.73958E−17 |
| E8 | 0 | 3.62156E−13 | E8 | 0 | −3.24923E−18 |
| E9 | 0 | 0 | E9 | 0 | 5.08768E−22 |
| E10 | 0 | −1.61888E−16 | E10 | 0 | 9.97713E−23 |
| | Sagittal | Sagittal | | Sagittal | Sagittal |
| | line tilt | line tilt | | line tilt | line tilt |
| M0_1 | 0 | 1.136E−01 | M0_1 | 1.499E−01 | −7.953E−02 |
| M1_1 | 0 | 0 | M1_1 | 2.041E−05 | 1.318E−05 |
| M2_1 | 0 | −5.071E−05 | M2_1 | 3.507E−08 | 1.547E−05 |
| M3_1 | 0 | 0 | M3_1 | −4.837E−08 | −4.462E−08 |
| M4_1 | 0 | 0 | M4_1 | 5.229E−10 | −1.812E−09 |
| M5_1 | 0 | 0 | M5_1 | 1.018E−11 | 8.807E−12 |
| M6_1 | 0 | 0 | M6_1 | −2.073E−13 | 1.663E−13 |
| M7_1 | 0 | 0 | M7_1 | −9.447E−16 | −7.761E−16 |
| M8_1 | 0 | 0 | M8_1 | 2.868E−18 | −2.426E−17 |
| M9_1 | 0 | 0 | M9_1 | 2.861E−20 | 2.113E−20 |
| M10_1 | 0 | 0 | M10_1 | −7.599E−23 | 4.798E−22 |
| M11_1 | 0 | 0 | M11_1 | 0 | 0 |
| M12_1 | 0 | 0 | M12_1 | 0 | 0 |

TABLE 12
fθ coefficient, Scanning width, Maximum angle of view

| | | |
|---|---|---|
| fθ coefficient | k (mm/rad) | 207 |
| Scanning width | W (mm) | 330 |
| Maximum angle of view | θ(deg) | 45.7 |

Refractive index

| | | |
|---|---|---|
| Refractive index of first fθ lenses 406 and 406 | N5 | 1.52819 |
| Refractive index of second fθ lenses 407 and 607 | N6 | 1.52819 |

Deflecting unit 1

| | | |
|---|---|---|
| Number of deflecting surfaces | | 4 |
| Circumscribed radius | Rpol (mm) | 10 |
| Rotation center - Deflection reference points | Xpol (mm) | −6.03 |
| D0 and E0 (Optical axis direction) | | |
| Rotation center - Deflection reference points | Ypol (mm) | 3.79 |
| D0 and E0 (main scanning direction) | | |

Arrangement in second and fourth scanning
optical systems 75b and 95b

| | | |
|---|---|---|
| Deflection reference points D0 and E0 - | d12 (mm) | 26.00 |
| Incident surface of first fθ lenses 406 and 606 | | |
| Incident surface of first fθ lenses 406 and 606 - | d13 (mm) | 8.20 |
| Exit surface of first fθ lenses 406 and 606 | | |
| Exit surface of first fθ lenses 406 and 606 - | d14 (mm) | 66.60 |
| Incident surface of second fθ lenses 407 and 607 | | |
| Incident surface of second fθ lenses 407 and 607 - | d15 (mm) | 4.30 |
| Exit surface of second fθ lenses 407 and 607 | | |
| Exit surface of second fθ lenses 407 and 607 - | d16 (mm) | 127.90 |
| Second and fourth scanned surfaces 408 and 608 | | |
| Deflection reference points D0 and E0 - | L3 (mm) | 26.00 |
| Incident surface of first ff lenses 406 and 606 | | |
| Deflection reference points D0 and E0 - | L4 (mm) | 100.80 |
| Incident surface of second fθ lenses 407 and 607 | | |
| Deflection reference points D0 and E0 - | T2 (mm) | 233.00 |
| Second and fourth scanned surfaces 408 and 608 | | |
| Sub-scanning eccentricity of second fθ | shiftZ | 5.96 |
| lenses 407 and 607 | (mm) | |

| | |
|---|---|
| Meridional line shape of | Meridional line shape of |
| first fθ lenses 406 and 606 | second fθ lenses 407 and 607 |

| | Incident | Exit surface | | Incident | Exit surface |
|---|---|---|---|---|---|
| | surface | Opposite | | surface | Opposite |
| | Opposite light | light | | Opposite light | light |
| | source side | source side | | source side | source side |
| R | −71.974 | −43.211 | R | −4000 | 345.598 |
| ku | 8.921E−01 | −5.727E−01 | ku | 0 | −9.021E+01 |
| B4u | −7.612E−07 | −1.995E−07 | B4u | 0 | −2.166E−07 |
| B6u | 6.789E−09 | 1.645E−09 | B6U | 0 | 1.801E−11 |
| B8u | −5.889E−12 | 1.272E−12 | B8u | 0 | −1.069E−15 |
| B10u | 1.617E−15 | −1.418E−15 | B10u | 0 | 2.983E−20 |
| B12u | 0 | 0 | B12u | 0 | 0 |
| | Light source | Light source | | Light source | Light source |
| | side | side | | side | side |
| k1 | 8.921E−01 | −5.727E−01 | k1 | 0 | −9.021E+01 |
| B41 | −7.612E−07 | −1.995E−07 | B41 | 0 | −2.166E−07 |
| B61 | 6.789E−09 | 1.645E−09 | B61 | 0 | 1.801E−11 |
| B81 | −5.889E−12 | 1.272E−12 | B81 | 0 | −1.069E−15 |
| B101 | 1.617E−15 | −1.418E−15 | B101 | 0 | 2.983E−20 |
| B121 | 0 | 0 | B121 | 0 | 0 |

| Sagittal line shape of | | | Sagittal line shape of | | |
|---|---|---|---|---|---|
| first fθ lenses 406 and 606 | | | second fθ lenses 407 and 607 | | |
| | Incident | | | Incident | |
| | surface | Exit surface | | surface | Exit surface |
| | Sagittal line | Sagittal line | | Sagittal line | Sagittal line |
| | R change | R change | | R change | R change |
| r | 20.000 | 20.586 | r | 26.855 | 294.0214 |
| E1 | 0 | 0 | E1 | 0 | 1.96971E−07 |
| E2 | 0 | 1.558E−05 | E2 | −5.144E−06 | −2.36769E−06 |
| E3 | 0 | 0 | E3 | 0 | −3.44358E−09 |
| E4 | 0 | −3.394E−08 | E4 | | −2.46843E−10 |
| E5 | 0 | 0 | E5 | 0 | 1.49969E−12 |
| E6 | 0 | 3.964E−11 | E6 | 0 | 1.69237E−14 |
| E7 | 0 | 0 | E7 | 0 | −2.50442E−16 |
| E8 | 0 | −6.55816E−14 | E8 | 0 | −1.79515E−18 |
| E9 | 0 | 0 | E9 | 0 | 1.40544E−20 |
| E10 | 0 | 5.40111E−17 | E10 | 0 | 7.11738E−23 |
| | Sagittal line | Sagittal line | | Sagittal line | Sagittal line |
| | tilt | tilt | | tilt | tilt |
| M0_1 | 0 | 3.928E−02 | M0_1 | −1.514E−01 | 1.072E−02 |
| M1_1 | 0 | 0 | M1_1 | −5.638E−06 | 2.983E−06 |
| M2_1 | 0 | −3.676E−05 | M2_1 | −2.604E−05 | −4.002E−05 |
| M3_1 | 0 | 0 | M3_1 | 1.312E−07 | 1.175E−07 |
| M4_1 | 0 | | M4_1 | 5.689E−09 | 7.909E−09 |
| M5_1 | 0 | 0 | M5_1 | −3.827E−11 | −3.145E−11 |
| M6_1 | 0 | 0 | M6_1 | 8.340E−14 | −6.667E−13 |
| M7_1 | 0 | 0 | M7_1 | 5.134E−15 | 3.847E−15 |
| M8_1 | 0 | 0 | M8_1 | −2.894E−17 | 8.307E−17 |
| M9_1 | 0 | 0 | M9_1 | −2.202E−19 | −1.374E−19 |
| M10_1 | 0 | 0 | M10_1 | −5.517E−22 | −5.821E−21 |
| M11_1 | 0 | 0 | M11_1 | 0 | 0 |
| M12_1 | 0 | 0 | M12_1 | 0 | 0 |

In Tables 10 to 12, an optical axis, an axis orthogonal to the optical axis in the main scanning cross section, and an axis orthogonal to the optical axis in the sub-scanning cross section are defined as an X-axis, a Y-axis and a Z-axis, respectively, when an intersection between each lens surface and the optical axis is defined as an origin. Further, in Tables 11 and 12, “E-x” means “×10^{-x}”.

An aspherical shape (meridional line shape) in the main scanning cross section of each lens surface of the first fθ lenses 306, 406, 506 and 606 and the second fθ lenses 307, 407, 507 and 607 provided in the light scanning apparatus 910 according to the aspect of the embodiment is expressed by the above-described Expression (1).

An aspherical shape (sagittal line shape) in the sub-scanning cross section of each lens surface of the first fθ lenses 306, 406, 506 and 606 and the second fθ lenses 307, 407, 507 and 607 provided in the light scanning apparatus 910 according to the aspect of the embodiment is expressed by the above-described Expression (2).

A curvature radius r′ in the sub-scanning cross section of each lens surface of the first fθ lenses 306, 406, 506 and 606 and the second fθ lenses 307, 407, 507 and 607 provided in the light scanning apparatus 910 according to the aspect of the embodiment continuously varies in accordance with a position in the Y direction as expressed by the above-described Expression (3).

Each of the first, second, third and fourth anamorphic collimator lenses 302, 402, 502 and 602 provided in the light scanning apparatus 910 according to the aspect of the embodiment has an incident surface formed by a diffracting surface defined by an optical path difference function of two variables Y and Z as expressed by the above-described Expression (4).

Further, in the first incident optical system 65a and the first scanning optical system 65b provided in the light scanning apparatus 910 according to the aspect of the embodiment, Inequality (11) be satisfied, Inequality (11a) be satisfied, and Inequality (11b) be satisfied.

Furthermore, in the first incident optical system 65a and the first scanning optical system 65b provided in the light scanning apparatus 910 according to the aspect of the embodiment, Inequalities (12) and (13) be satisfied.

Specifically, in the first incident optical system 65a and the first scanning optical system 65b provided in the light scanning apparatus 910 according to the aspect of the embodiment, β is −3.65, D is 34.2 mm, Lis 161.7 mm, and M is 0.138.

Therefore, the value of each of the Inequalities (11), (11a) and (11b) are calculated as 0.638, so that Inequalities (11) and (11a) are satisfied.

On the other hand, in the first incident optical system 65a and the first scanning optical system 65b provided in the light scanning apparatus 910 according to the aspect of the embodiment, M₀₁ is 0.114.

Therefore, the value of the Inequality (12) is calculated as 0.527, so that Inequality (12) is not satisfied.

Further, in the first incident optical system 65a and the first scanning optical system 65b provided in the light scanning apparatus 910 according to the aspect of the embodiment, Lₛ is 1.31 mm, and R is 54.586 mm.

Therefore, the value of the Inequality (13) is calculated as 0.638, so that Inequality (13) is satisfied.

In the second incident optical system 75a and the second scanning optical system 75b provided in the light scanning apparatus 910 according to the aspect of the embodiment, Inequality (11) be satisfied, Inequality (11a) be satisfied, and Inequality (11b) be satisfied.

Further, in the second incident optical system 75a and the second scanning optical system 75b provided in the light scanning apparatus 910 according to the aspect of the embodiment, Inequalities (12) and (13) be satisfied.

Specifically, in the second incident optical system 75a and the second scanning optical system 75b provided in the light scanning apparatus 910 according to the aspect of the embodiment, β is −3.65, D is 34.2 mm, Lis 161.7 mm and M is 0.103.

Therefore, the value of each of the Inequalities (11), (11a) and (11b) is calculated as 0.476, so that Inequalities (11), (11a) and (11b) are satisfied.

Further, in the second incident optical system 75a and the second scanning optical system 75b provided in the light scanning apparatus 910 according to the aspect of the embodiment, M₀₁ is 0.0393.

Therefore, the value of Inequality (12) is calculated as 0.182, so that Inequality (12) is satisfied.

Furthermore, in the second incident optical system 75a and the second scanning optical system 75b provided in the light scanning apparatus 910 according to the aspect of the embodiment, Lₛ is 1.31 mm, and R is 20.586 mm.

Therefore, the value of Inequality (13) is calculated as 0.476, and Inequality (13) is satisfied.

Further, in the third incident optical system 85a and the third scanning optical system 85b provided in the light scanning apparatus 910 according to the aspect of the embodiment, Inequality (11) be satisfied.

In other words, an inclination at the arrival position of the light beam from the k-th light emitting point of the third light source 501 on the exit surface (third sagittal line tilt surface, third optical surface) of the first fθ lens 506 provided in the light scanning apparatus 910 according to the aspect of the embodiment is represented by M₃ₖ.

A lateral magnification in the sub-scanning cross section of the third incident optical system 85a is represented by β3.

A distance on the optical axis of the third incident optical system 85a between the third light source 501 and the second deflecting surface of the deflecting unit 1 provided in the light scanning apparatus 910 according to the aspect of the embodiment is represented by L₃ (mm).

A distance on the optical axis of the third scanning optical system 85b between the second deflecting surface of the deflecting unit 1 and the exit surface of the first fθ lens 506 provided in the light scanning apparatus 910 according to the aspect of the embodiment is represented by D₃ (mm).

At this time, in the third incident optical system 85a and the third scanning optical system 85b provided in the light scanning apparatus 910 according to the aspect of the embodiment, the following Inequality (11e) be satisfied:

$$0.05 < \vert {M}_{3 k} [ - {β}_{3} + \frac{( 1 - {β}_{3} ) {D}_{3}}{{L}_{3}} ] \vert < 0.7 . \qquad ( 11 e )$$

Further, in the third incident optical system 85a and the third scanning optical system 85b provided in the light scanning apparatus 910 according to the aspect of the embodiment, Inequality (11a) be satisfied, and it is more preferred that Inequality (11b) be satisfied.

Furthermore, in the third incident optical system 85a and the third scanning optical system 85b provided in the light scanning apparatus 910 according to the embodiment, Inequalities (12) and (13) be satisfied.

Specifically, in the third incident optical system 85a and the third scanning optical system 85b provided in the light scanning apparatus 910 according to the aspect of the embodiment, β is −3.65, D is 34.2 mm, Lis 161.7 mm, and M is 0.138.

Therefore, the value of each of Inequalities (11), (11a) and (11b) is calculated as 0.638, so that Inequalities (11) and (11a) are satisfied.

On the other hand, in the third incident optical system 85a and the third scanning optical system 85b provided in the light scanning apparatus 910 according to the aspect of the embodiment, M₀₁ is 0.114.

Therefore, the value of Inequality (12) is calculated as 0.527, so that Inequality (12) is not satisfied.

Further, in the third incident optical system 85a and the third scanning optical system 85b provided in the light scanning apparatus 910 according to the aspect of the embodiment, Lₛ is 1.31 mm, and R is 54.586 mm.

Therefore, the value of Inequality (13) is calculated as 0.638, so that Inequality (13) is satisfied.

In addition, in the fourth incident optical system 95a and the fourth scanning optical system 95b provided in the light scanning apparatus 910 according to the aspect of the embodiment, Inequality (11) be satisfied.

In other words, an inclination at the arrival position of the light beam from the 1-th light emitting point of the fourth light source 601 on the exit surface (fourth sagittal line tilt surface, fourth optical surface) of the first fθ lens 606 provided in the light scanning apparatus 910 according to the aspect of the embodiment is represented by M₄ₗ.

A lateral magnification in the sub-scanning cross section of the fourth incident optical system 95a is represented by β₄.

A distance on the optical axis of the fourth incident optical system 95a between the fourth light source 601 and the second deflecting surface of the deflecting unit 1 provided in the light scanning apparatus 910 according to the aspect of the embodiment is represented by L₄ (mm).

A distance on the optical axis of the fourth scanning optical system 95b between the second deflecting surface of the deflecting unit 1 and the exit surface of the first fθ lens 606 provided in the light scanning apparatus 910 according to the aspect of the embodiment is represented by D₄ (mm).

At this time, in the fourth incident optical system 95a and the fourth scanning optical system 95b provided in the light scanning apparatus 910 according to the aspect of the embodiment, the following Inequality (11f) be satisfied:

$$0.05 < \vert {M}_{4 l} [ - {β}_{4} + \frac{( 1 - {β}_{4} ) {D}_{4}}{{L}_{4}} ] \vert < 0.7 . \qquad ( 11 f )$$

Further, in the fourth incident optical system 95a and the fourth scanning optical system 95b provided in the light scanning apparatus 910 according to the aspect of the embodiment, Inequality (11a) be satisfied, and it is more preferred that Inequality (11b) be satisfied.

Furthermore, in the fourth incident optical system 95a and the fourth scanning optical system 95b provided in the light scanning apparatus 910 according to the aspect of the embodiment, Inequalities (12) and (13) be satisfied.

Specifically, in the fourth incident optical system 95a and the fourth scanning optical system 95b provided in the light scanning apparatus 910 according to the aspect of the embodiment, β is −3.65, D is 34.2 mm, Lis 161.7 mm, and M is 0.103.

Therefore, the value of each of Inequalities (11), (11a) and (11b) is calculated as 0.476, so that Inequalities (11), (11a) and (11b) are satisfied.

Further, in the fourth incident optical system 95a and the fourth scanning optical system 95b provided in the light scanning apparatus 910 according to the aspect of the embodiment, M₀₁ is 0.0393.

Therefore, the value of Inequality (12) is calculated as 0.182, so that Inequality (12) is satisfied.

Furthermore, in the fourth incident optical system 95a and the fourth scanning optical system 95b provided in the light scanning apparatus 910 according to the aspect of the embodiment, Lₛ is 1.31 mm, and R is 20.586 mm.

Therefore, the value of Inequality (13) is calculated as 0.476, and Inequality (13) is satisfied.

As described above, in the light scanning apparatus 910 according to the aspect of the embodiment, Inequality (11) is satisfied in the first incident optical system 65a and the first scanning optical system 65b, thereby it is possible to suppress a deterioration in the image quality due to the deviation of the arrival position of each light beam on the first scanned surface 308.

In the light scanning apparatus 910 according to the aspect of the embodiment, Inequality (11) is satisfied in the second incident optical system 75a and the second scanning optical system 75b, thereby it is possible to suppress a deterioration in the image quality due to the deviation of the arrival position of each light beam on the second scanned surface 408.

In the light scanning apparatus 910 according to the aspect of the embodiment, Inequality (11) is satisfied in the third incident optical system 85a and the third scanning optical system 85b, thereby it is possible to suppress a deterioration in the image quality due to the deviation of the arrival position of each light beam on the third scanned surface 508.

In the light scanning apparatus 910 according to the aspect of the embodiment, Inequality (11) is satisfied in the fourth incident optical system 95a and the fourth scanning optical system 95b, thereby it is possible to suppress a deterioration in the image quality due to the deviation of the arrival position of each light beam on the fourth scanned surface 608.

Numerical values of the respective Inequalities in each of the light scanning apparatuses according to the first to fifth embodiments described above are shown in the following Table 13.

TABLE 13

| | First | Second | Third |
|---|---|---|---|
| | embodiment | embodiment | embodiment |
| β | −3.65 | −3.65 | −3.65 |
| D [mm] | 34.2 | 34.2 | 34.2 |
| L [mm] | 161.7 | 161.7 | 161.7 |
| M | −0.127 | −0.0385 | −0.0735 |
| M01 | −0.0918 | −0.0385 | −0.0212 |
| Ls [mm] | −1.45 | 0 | −1.31 |
| R [mm] | 41.166 | 76.858 | 25.004 |
| Inequality (11): 0.05<\| | 0.589 | 0.179 | 0.341 |
| (−β + (1 − β) × D/L) × M\|<0.70 | | | |
| Inequality (11a): 0.10<\| | | | |
| (−β + (1 − β) × D/L) × M\|<0.65 | | | |
| Inequality (11b): 0.15<\| | | | |
| (−β + (1 − β) × D/L) × M\|<0.60 | | | |
| Inequality (12): 0<\| (−β + | 0.426 | 0.179 | 0.098 |
| (1 − β) × D/L) × M01\|<0.185 | | | |
| Inequality (13): 0.05<\| (−β + | 0.589 | 0.179 | 0.341 |
| (1 − β) × D/L) × (Ls/R + | | | |
| M01) \|<0.70 | | | |
| 1/R [1/mm] | 0.0243 | 0.0130 | 0.0400 |

| | Fourth embodiment | | Fifth embodiment | |
|---|---|---|---|---|
| | First scanning | Second scanning | First and third | Second and fourth |
| | system | system | scanning systems | scanning systems |
| β | −3.65 | −3.65 | −3.65 | −3.65 |
| D [mm] | 34.2 | 34.2 | 34.2 | 34.2 |
| L [mm] | 161.7 | 161.7 | 161.7 | 161.7 |
| M | 0.100 | 0.0735 | 0.138 | 0.103 |
| M01 | 0.0766 | 0.0212 | 0.114 | 0.0393 |
| Ls [mm] | 1.31 | 1.31 | 1.31 | 1.31 |
| R [mm] | 55.261 | 25.004 | 54.586 | 20.586 |
| Inequality (11): 0.05<\| | 0.465 | 0.341 | 0.638 | 0.476 |
| (−β + (1 − β) × D/L) × | | | | |
| M\|<0.70 | | | | |
| Inequality (11a): 0.10<\| | | | | |
| (−β + (1 − β) × D/L) × | | | | |
| M\|<0.65 | | | | |
| Inequality (11b): 0.15<\| | | | | |
| (−β + (1 − β) × D/L) × | | | | |
| M\|<0.60 | | | | |
| Inequality (12): 0<\| (−β + | 0.355 | 0.098 | 0.527 | 0.182 |
| (1 − β) × D/L) × M01\|<0.185 | | | | |
| Inequality (13): 0.05<\| | 0.465 | 0.341 | 0.638 | 0.476 |
| (−β + (1 − β) × D/L) × | | | | |
| (Ls/R + M01) \|<0.70 | | | | |
| 1/R [1/mm] | 0.0181 | 0.0400 | 0.0183 | 0.0486 |

According to the aspect of the embodiments, a light scanning apparatus capable of easily reducing a deviation between scanning widths of multiple beams can be provided.

Although preferred embodiments have been described above, the disclosure is not limited to these embodiments, and various modifications and changes can be made within the scope of the gist of the disclosure.

### [Image Forming Apparatus]

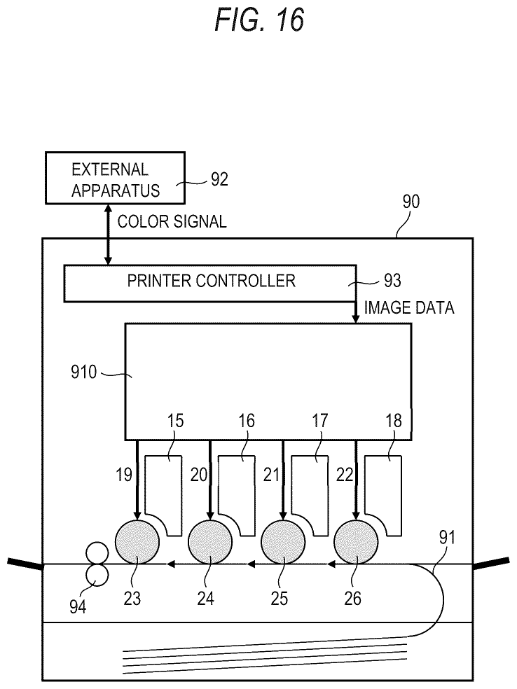

FIG. 16 shows a sub-scanning cross sectional view of a main part of an image forming apparatus 90 in which the light scanning apparatus 910 according to the fifth embodiment of the disclosure is mounted.

The image forming apparatus 90 is a tandem-type color image forming apparatus that records image information on a surface of each photosensitive drum serving as an image carrier by using the light scanning apparatus 910 according to the fifth embodiment.

The image forming apparatus 90 includes the light scanning apparatus 910 according to the fifth embodiment, developing units 15, 16, 17 and 18, photosensitive drums (photosensitive bodies) 23, 24, 25 and 26, a conveying belt 91, a printer controller 93 and a fixing unit 94.

Color signals (code data) of R (red), G (green) and B (blue) output from an external apparatus 92 such as a personal computer are input to the image forming apparatus 90.

The input color signals are converted into image data (dot data) of C (cyan), M (magenta), Y (yellow), and K (black) by the printer controller 93 in the image forming apparatus 90.

The converted image data is input to the light scanning apparatus 910 according to the fifth embodiment.

Light beams 19, 20, 21, and 22 modulated in accordance with respective image data are emitted from the light scanning apparatus 910 according to the fifth embodiment, and photosensitive surfaces of photosensitive drums 23, 24, 25 and 26 are exposed to the light beams 19 to 22.

In the image forming apparatus 90, charging rollers (not shown) for uniformly charging the surfaces of the photosensitive drums 23 to 26 are provided so as to abut on the surfaces.

The surfaces of the photosensitive drums 23 to 26 charged by the charging rollers are irradiated with the light beams 19 to 22 from the light scanning apparatus 910 according to the fifth embodiment.

As described above, the light beams 19 to 22 are modulated on the basis of the image data of the respective colors, and electrostatic latent images are formed on the surfaces of the photosensitive drums 23 to 26 by the irradiation with the light beams 19 to 22.

The formed electrostatic latent images are developed as toner images by developing units 15, 16, 17 and 18 arranged so as to abut on the photosensitive drums 23 to 26.

The toner images developed by the developing units 15 to 18 are multi-transferred onto a sheet (transferred material) (not shown) conveyed on the conveying belt 91 by a transferring roller (transferring unit) (not shown) arranged so as to face the photosensitive drums 23 to 26, thereby forming one full-color image.

Then, the sheet on which the unfixed toner image is transferred is further conveyed to the fixing unit 94 arranged behind the photosensitive drums 23 to 26 (on the left side in FIG. 16).

The fixing unit 94 is formed by a fixing roller having a fixing heater (not shown) therein and a pressurizing roller arranged so as to be in pressure contact with the fixing roller.

Then, the sheet conveyed from the transferring portion is heated while being pressed at the pressure-contact portion between the fixing roller and the pressurizing roller, thereby the unfixed toner image on the sheet is fixed.

Further, a sheet discharging roller (not shown) is arranged behind the fixing roller, and the sheet discharging roller discharges the sheet on which the toner image is fixed to the outside of the image forming apparatus 90.

The image forming apparatus 90 records image signals (image information) on the photosensitive surfaces of the photosensitive drums 23 to 26 corresponding to the respective colors of C, M, Y and K by using the light scanning apparatus 910 according to the fifth embodiment, and prints a color image at high speed.

As the external apparatus 92, for example, a color image reading apparatus including a CCD sensor may be used. In this case, the color image reading apparatus and the image forming apparatus 90 form a color digital copying machine.

The image forming apparatus 90 may be provided with four light scanning apparatuses according to any one of the first to third embodiments or two light scanning apparatuses 710 according to the fourth embodiment instead of the light scanning apparatus 910 according to the fifth embodiment.

While the embodiments of the disclosure have been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-019123, filed Feb. 13, 2024, which is hereby incorporated by reference herein in its entirety.

What is claimed is:

1. An apparatus comprising:
a deflecting unit configured to deflect a plurality of light fluxes from a first light source with a plurality of light emitting points to scan a first scanned surface in a main scanning direction;
a first element having a first surface and configured to guide the plurality of light fluxes deflected by a first deflecting surface of the deflecting unit to the first scanned surface; and
a first incident system configured to cause the plurality of light fluxes from the first light source to be incident on the first deflecting surface,
wherein, a following condition is satisfied:
$$0.05 < \vert {M}_{1 i} [ - {β}_{1} + \frac{( 1 - {β}_{1} ) {D}_{1}}{{L}_{1}} ] \vert < 0. 70 ,$$
where L₁ represents a distance between the first light source and the first deflecting surface on an optical axis of the first incident system, D₁ represents a distance between the first deflecting surface and the first surface on an optical axis of the first element, β₁ represents a lateral magnification in a sub-scanning cross section of the first incident system, and M₁ᵢ represents an inclination of the first surface at a position at which the light flux from an i-th light emitting point of the first light source arrives on the first surface.

2. The apparatus according to claim 1, wherein a following condition is satisfied:
$$0 < \vert {M}_{01} [ - {β}_{1} + \frac{( 1 - {β}_{1} ) {D}_{1}}{{L}_{1}} ] \vert < 0. 185 ,$$
where M₀₁ represents a sagittal line tilt amount of the first surface on the optical axis of the first element.

3. The apparatus according to claim 1, wherein a following condition is satisfied:
$$0.05 < \vert [ \frac{{L}_{s}}{R} + {M}_{01} ] \times [ - {β}_{1} + \frac{( 1 - {β}_{1} ) {D}_{1}}{{L}_{1}} ] \vert < 0. 70 ,$$
where R represents a curvature radius in the sub-scanning cross section of the first surface on the optical axis of the first element, Lₛ represents an eccentricity amount in a sub-scanning direction of the first element, and M₀₁ represents a sagittal line tilt amount of the first surface on the optical axis of the first element.

4. The apparatus according to claim 1, wherein a sagittal line tilt amount of the first surface varies in accordance with a position in the main scanning direction.

5. The apparatus according to claim 4, wherein an absolute value of a sagittal line tilt amount of the first surface is largest on the optical axis of the first element.

6. The apparatus according to claim 1, wherein the first element has a positive power in the sub-scanning cross section.

7. The apparatus according to claim 1, further comprising a first imaging system including the first element and configured to guide the plurality of light fluxes deflected by the first deflecting surface to the first scanned surface,
wherein an element closest to the deflecting unit on the paths of the plurality of light fluxes among at least one element included in the first imaging system is an element having the strongest power in a main scanning cross section among the at least one element.

8. The apparatus according to claim 1, further comprising:
a second element having a second surface and configured to guide a plurality of light fluxes of a second light source with a plurality of light emitting points deflected by the first deflecting surface to a second scanned surface; and
a second incident system configured to cause the plurality of light fluxes from the second light source to be incident on the first deflecting surface,
wherein the deflecting unit is configured to deflect the plurality of light fluxes from the second light source to scan the second scanned surface in the main scanning direction, and
wherein, a following condition is satisfied:
$$0.05 < \vert {M}_{2 j} [ - {β}_{2} + \frac{( 1 - {β}_{2} ) {D}_{2}}{{L}_{2}} ] \vert < 0. 70 ,$$
where L₂ represents a distance between the second light source and the first deflecting surface on an optical axis of the second incident system, D₂ represents a distance between the first deflecting surface and the second surface on an optical axis of the second element, β₂ represents a lateral magnification in the sub-scanning cross section of the second incident system, and M₂ⱼ represents an inclination of the second surface at a position at which the light flux from a j-th light emitting point of the second light source arrives on the second surface.

9. The apparatus according to claim 8, wherein an absolute value of a sagittal line tilt amount of the first surface on the optical axis of the first element and an absolute value of a sagittal line tilt amount of the second surface on the optical axis of the second element are different from each other.

10. The apparatus according to claim 8, further comprising:
a third element having a third surface and configured to guide a plurality of light fluxes of a third light source with a plurality of light emitting points deflected by a second deflecting surface of the deflecting unit to a third scanned surface;
a fourth element having a fourth surface and configured to guide a plurality of light fluxes of a fourth light source with a plurality of light emitting points deflected by the second deflecting surface to a fourth scanned surface;
a third incident system configured to cause the plurality of light fluxes from the third light source to be incident on the second deflecting surface; and
a fourth incident system configured to cause the plurality of light fluxes from the fourth light source to be incident on the second deflecting surface,
wherein the deflecting unit is configured to deflect the plurality of light fluxes from the third light source and the plurality of light fluxes from the fourth light source to scan the third and fourth scanned surfaces in the main scanning direction, respectively,
wherein, a following condition is satisfied:
$$0.05 < \vert {M}_{3 k} [ - {β}_{3} + \frac{( 1 - {β}_{3} ) {D}_{3}}{{L}_{3}} ] \vert < 0. 70 ,$$
where L₃ represents a distance between the third light source and the second deflecting surface on an optical axis of the third incident system, D₃ represents a distance between the second deflecting surface and the third surface on an optical axis of the third element, β₃ represents a lateral magnification in the sub-scanning cross section of the third incident system, and M₃ₖ represents an inclination of the third surface at a position at which the light flux from a k-th light emitting point of the third light source arrives on the third surface, and
wherein, a following condition is satisfied:
$$0.05 < \vert {M}_{4 l} [ - {β}_{4} + \frac{( 1 - {β}_{4} ) {D}_{4}}{{L}_{4}} ] \vert < 0. 70 ,$$
where L₄ represents a distance between the fourth light source and the second deflecting surface on an optical axis of the fourth incident system, D₄ represents a distance between the second deflecting surface and the fourth surface on an optical axis of the fourth element, β₄ represents a lateral magnification in the sub-scanning cross section of the fourth incident system, and M₄ₗ represents an inclination of the fourth surface at a position at which the light flux from an 1-th light emitting point of the fourth light source arrives on the fourth surface.

11. An apparatus comprising:
a deflecting unit configured to deflect a plurality of light fluxes from a first light source with a plurality of light emitting points to scan a first scanned surface in a main scanning direction;
a first element having a first surface and configured to guide the plurality of light fluxes deflected by a first deflecting surface of the deflecting unit to the first scanned surface; and
a first incident system configured to cause the plurality of light fluxes from the first light source to be incident on the first deflecting surface,
wherein a normal of the first surface on an optical axis of the first element is inclined with respect to the optical axis.

12. A forming apparatus comprising:
the apparatus according to claim 1; and
a developing unit configured to develop an electrostatic latent image formed on the first scanned surface by the apparatus.

13. The forming apparatus according to claim 12, wherein, in the apparatus, a following condition is satisfied:
$$0 < \vert {M}_{01} [ - {β}_{1} + \frac{( 1 - {β}_{1} ) {D}_{1}}{{L}_{1}} ] \vert < 0. 185 ,$$
where M₀₁ represents a sagittal line tilt amount of the first surface on the optical axis of the first element.

14. The forming apparatus according to claim 12, wherein, in the apparatus, a following condition is satisfied:
$$0.05 < \vert [ \frac{{L}_{s}}{R} + {M}_{01} ] \times [ - {β}_{1} + \frac{( 1 - {β}_{1} ) {D}_{1}}{{L}_{1}} ] \vert < 0. 70 ,$$
where R represents a curvature radius in the sub-scanning cross section of the first surface on the optical axis of the first element, Lₛ represents an eccentricity amount in a sub-scanning direction of the first element, and M₀₁ represents a sagittal line tilt amount of the first surface on the optical axis of the first element.

15. The forming apparatus according to claim 12, wherein, in the apparatus, a sagittal line tilt amount of the first surface varies in accordance with a position in the main scanning direction.

16. The forming apparatus according to claim 15, wherein, in the apparatus, an absolute value of a sagittal line tilt amount of the first surface is largest on the optical axis of the first element.

17. A forming apparatus comprising:
the apparatus according to claim 1; and
a controller configured to convert a signal output from an external apparatus into image data to input the image data to the apparatus.

18. The forming apparatus according to claim 17, wherein, in the apparatus, a following condition is satisfied:
$$0 < \vert {M}_{01} [ - {β}_{1} + \frac{( 1 - {β}_{1} ) {D}_{1}}{{L}_{1}} ] \vert < 0. 185 ,$$
where M₀₁ represents a sagittal line tilt amount of the first surface on the optical axis of the first element.

19. The forming apparatus according to claim 17, wherein, in the apparatus, a following condition is satisfied:
$$0.05 < \vert [ \frac{{L}_{s}}{R} + {M}_{01} ] \times [ - {β}_{1} + \frac{( 1 - {β}_{1} ) {D}_{1}}{{L}_{1}} ] \vert < 0. 70 ,$$
where R represents a curvature radius in the sub-scanning cross section of the first surface on the optical axis of the first element, Lₛ represents an eccentricity amount in a sub-scanning direction of the first element, and M₀₁ represents a sagittal line tilt amount of the first surface on the optical axis of the first element.

20. The forming apparatus according to claim 17, wherein, in the apparatus, a sagittal line tilt amount of the first surface varies in accordance with a position in the main scanning direction.
